(19) United States
(12) Patent Application Publication
(10) Pub. No.: US 2025/0063510 A1
(43) Pub. Date: Feb. 20, 2025

(54) HANDLING OF USER EQUIPMENT RESOURCE-CONSTRAINED STATE

(71) Applicant: QUALCOMM Incorporated, San Diego, CA (US)

(72) Inventors: Mohsen BAHRAMI, Carlsbad, CA (US); Soumya DAS, San Diego, CA (US)

(21) Appl. No.: 18/451,334

(22) Filed: Aug. 17, 2023

(51) Int. Cl. H04W 52/02; H04W 72/56

(52) U.S. Cl. CPC H04W 52/0261; H04W 72/56

(57) ABSTRACT

Various aspects of the present disclosure generally relate to wireless communication. In some aspects, a user equipment (UE) may transmit, based at least in part on a thermal-resource-constrained state of the UE or a power-resource-constrained state of the UE, a request to deactivate one or more quality of experience (QoE) measurement and collection (QMC) configurations for one or more applications. The UE may receive an indication to deactivate the one or more QMC configurations. In some aspects, the UE may enter the thermal-resource-constrained state or the power-resource-constrained state. The UE may transmit, in a QoE report container, an indication that the UE is in the thermal-resource-constrained state or the power-resource-constrained state. Numerous other aspects are described.

### FIELD OF THE DISCLOSURE

Aspects of the present disclosure generally relate to wireless communication and to techniques and apparatuses for handling a user equipment resource-constrained state.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to cause the UE to transmit, based at least in part on a thermal-resource-constrained state of the UE or a power-resource-constrained state of the UE, a request to deactivate one or more quality of experience (QoE) measurement and collection (QMC) configurations for one or more applications. The one or more processors may be configured to cause the UE to receive an indication to deactivate the one or more QMC configurations.

Some aspects described herein relate to a UE for wireless communication. The UE may include one or more memories and one or more processors coupled to the one or more memories. The one or more processors may be configured to cause the UE to enter a thermal-resource-constrained state or a power-resource-constrained state. The one or more processors may be configured to cause the UE to transmit, in a QoE report container, an indication that the UE is in the thermal-resource-constrained state or the power-resource-constrained state.

Some aspects described herein relate to a network node for wireless communication. The network node may include one or more memories and one or more processors coupled to the one or more memories. The one or more processors may be configured to cause the network node to obtain, based at least in part on a thermal-resource-constrained state of a UE or a power-resource-constrained state of the UE, a request to deactivate one or more QMC configurations for one or more applications. The one or more processors may be configured to cause the network node to output an indication to deactivate the one or more QMC configurations.

Some aspects described herein relate to a network node for wireless communication. The network node may include one or more memories and one or more processors coupled to the one or more memories. The one or more processors may be configured to cause the network node to obtain, in a QoE report container, an indication that a UE is in a thermal-resource-constrained state or a power-resource-constrained state. The one or more processors may be configured to cause the network node to output, in the QoE report container, to an operations, administration, and maintenance (OAM) server, the indication that the UE is in the thermal-resource-constrained state or the power-resource-constrained state.

Some aspects described herein relate to a method of wireless communication performed by a UE. The method may include transmitting, based at least in part on a thermal-resource-constrained state of the UE or a power-resource-constrained state of the UE, a request to deactivate one or more QMC configurations for one or more applications. The method may include receiving an indication to deactivate the one or more QMC configurations.

Some aspects described herein relate to a method of wireless communication performed by a UE. The method may include entering a thermal-resource-constrained state or a power-resource-constrained state. The method may include transmitting, in a QoE report container, an indication that the UE is in the thermal-resource-constrained state or the power-resource-constrained state.

Some aspects described herein relate to a method of wireless communication performed by a network node. The method may include obtaining, based at least in part on a thermal-resource-constrained state of a UE or a power-resource-constrained state of the UE, a request to deactivate one or more QMC configurations for one or more applications. The method may include outputting an indication to deactivate the one or more QMC configurations.

Some aspects described herein relate to a method of wireless communication performed by a network node. The method may include obtaining, in a QoE report container, an indication that a UE is in a thermal-resource-constrained state or a power-resource-constrained state. The method may include outputting, in the QoE report container, to an OAM server, the indication that the UE is in the thermal-resource-constrained state or the power-resource-constrained state.

Some aspects described herein relate to a non-transitory computer-readable medium that stores a set of instructions for wireless communication by a UE. The set of instructions, when executed by one or more processors of the UE, may cause the UE to transmit, based at least in part on a thermal-resource-constrained state of the UE or a power-resource-constrained state of the UE, a request to deactivate one or more QMC configurations for one or more applications. The set of instructions, when executed by one or more processors of the UE, may cause the UE to receive an indication to deactivate the one or more QMC configurations.

Some aspects described herein relate to a non-transitory computer-readable medium that stores a set of instructions for wireless communication by a UE. The set of instructions, when executed by one or more processors of the UE, may cause the UE to enter a thermal-resource-constrained state or a power-resource-constrained state. The set of instructions, when executed by one or more processors of the UE, may cause the UE to transmit, in a QoE report container, an indication that the UE is in the thermal-resource-constrained state or the power-resource-constrained state.

Some aspects described herein relate to a non-transitory computer-readable medium that stores a set of instructions for wireless communication by a network node. The set of instructions, when executed by one or more processors of the network node, may cause the network node to obtain, based at least in part on a thermal-resource-constrained state of a UE or a power-resource-constrained state of the UE, a request to deactivate one or more QMC configurations for one or more applications. The set of instructions, when executed by one or more processors of the network node, may cause the network node to output an indication to deactivate the one or more QMC configurations.

Some aspects described herein relate to a non-transitory computer-readable medium that stores a set of instructions for wireless communication by a network node. The set of instructions, when executed by one or more processors of the network node, may cause the network node to obtain, in a QoE report container, an indication that a UE is in a thermal-resource-constrained state or a power-resource-constrained state. The set of instructions, when executed by one or more processors of the network node, may cause the network node to output, in the QoE report container, to an OAM server, the indication that the UE is in the thermal-resource-constrained state or the power-resource-constrained state.

Some aspects described herein relate to an apparatus for wireless communication. The apparatus may include means for transmitting, based at least in part on a thermal-resource-constrained state of the apparatus or a power-resource-constrained state of the apparatus, a request to deactivate one or more QMC configurations for one or more applications. The apparatus may include means for receiving an indication to deactivate the one or more QMC configurations.

Some aspects described herein relate to an apparatus for wireless communication. The apparatus may include means for entering a thermal-resource-constrained state or a power-resource-constrained state. The apparatus may include means for transmitting, in a QoE report container, an indication that the apparatus is in the thermal-resource-constrained state or the power-resource-constrained state.

Some aspects described herein relate to an apparatus for wireless communication. The apparatus may include means for obtaining, based at least in part on a thermal-resource-constrained state of a UE or a power-resource-constrained state of the UE, a request to deactivate one or more QMC configurations for one or more applications. The apparatus may include means for outputting an indication to deactivate the one or more QMC configurations.

Some aspects described herein relate to an apparatus for wireless communication. The apparatus may include means for obtaining, in a QoE report container, an indication that a UE is in a thermal-resource-constrained state or a power-resource-constrained state. The apparatus may include means for outputting, in the QoE report container, to an OAM server, the indication that the UE is in the thermal-resource-constrained state or the power-resource-constrained state.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of quality of experience (QoE) measurement and collection (QMC), in accordance with the present disclosure.

FIG. 5 is a diagram illustrating an example associated with deactivation of one or more QMC configurations based on a UE resource-constrained state, in accordance with the present disclosure.

FIGS. 6A-6C are diagrams illustrating examples associated with signaling for handling a UE thermal-resource-constrained state, in accordance with the present disclosure.

FIG. 7 is a diagram illustrating an example of capability information including an indication that the UE is capable of transmitting a request to deactivate QMC configurations for applications for a thermal-resource-constrained state, in accordance with the present disclosure.

FIG. 8 is a diagram illustrating an example of a UE assistance information (UAI) message that contains the request to deactivate one or more QMC configurations, in accordance with the present disclosure.

FIGS. 9A-9C are diagrams illustrating examples associated with signaling for handling a UE power-resource-constrained state, in accordance with the present disclosure.

FIG. 10 is a diagram illustrating an example of capability information including an indication that the UE is capable of transmitting a request to deactivate QMC configurations for applications for a power-resource-constrained state, in accordance with the present disclosure.

FIG. 11 is a diagram illustrating an example of a field for configuring the UE with a timer configured to start based at least in part on the UE entering a power-resource-constrained state, in accordance with the present disclosure.

FIG. 12 is a diagram illustrating an example of a UAI message that contains the request to deactivate one or more QMC configurations, in accordance with the present disclosure.

FIG. 13 is a diagram illustrating an example associated with indication of a UE resource-constrained state, in accordance with the present disclosure.

FIG. 14 is a diagram illustrating an example associated with indication of a vehicular UE thermal-resource-constrained state, in accordance with the present disclosure.

FIG. 15 is a diagram illustrating an example process performed, for example, by a UE, in accordance with the present disclosure.

FIG. 16 is a diagram illustrating an example process performed, for example, by a UE, in accordance with the present disclosure.

FIG. 17 is a diagram illustrating an example process performed, for example, by a network node, in accordance with the present disclosure.

FIG. 18 is a diagram illustrating an example process performed, for example, by a network node, in accordance with the present disclosure.

FIG. 19 is a diagram of an example apparatus for wireless communication, in accordance with the present disclosure.

FIG. 20 is a diagram of an example apparatus for wireless communication, in accordance with the present disclosure.

### DETAILED DESCRIPTION

A user equipment (UE) can enter a thermal-resource-constrained state (e.g., when the UE is experiencing overheating) and/or a power-resource-constrained state (e.g., when the UE is low on power, such as when the power falls below a power threshold). When in a thermal-resource-constrained state or a power-resource-constrained state, the UE may implement one or more thermal-mitigation mechanisms or power-saving mechanisms, which may enable the UE to satisfy a temperature or power threshold and, thus, exit the thermal-resource-constrained state or the power-resource-constrained state.

In 5G New Radio (NR), UE assistance information (UAI) may indicate, to a network node, UE preferences regarding mitigation actions for UE overheating and/or power saving. However, no mechanisms exist within the NR quality of experience (QoE) and UAI frameworks that enable the UE to indicate a preference for suspension of QoE measurement and collection (QMC) configurations for the purposes of thermal mitigation and/or power saving. As a result, a UE may continue to report QoE measurements (e.g., for non-critical applications), in accordance with a QMC configuration, after entering a thermal-resource-constrained state and/or a power-resource-constrained state. Reporting QoE measurements in a thermal-resource-constrained state may extend the length of time during which the UE remains in the thermal-resource-constrained state and/or may raise the internal temperature of the UE. Reporting QoE measurements in a power-resource-constrained state may cause the UE to lose power faster than the UE would if the UE were not configured to report the QoE measurements during the power-resource-constrained state.

Furthermore, the UE may implement certain mitigation actions or strategies for overheating and power saving, such as lowering central processing unit (CPU) utilization, modem configuration, or the like. These mitigation actions can decrease QoE (e.g., by degrading vehicular UE performance and impacting telematics and in-vehicle infotainment applications) but are not reported to an operations, administration, and maintenance (OAM) server. As a result, upon obtaining a QoE report that indicates the decreased QoE, in accordance with the Third Generation Partnership Project (3GPP) NR QoE framework, the OAM server may initiate ineffective QoE improvement actions, such as prompting a network node (e.g., a next generation radio access network (NG-RAN)) to adjust network resources and/or prompting the application server to customize application configurations to improve the overall user experience (e.g., the QoE). These QoE improvement actions are ineffective because the decreased QoE is due to the mitigation actions performed by the UE, rather than due to inadequate network resources, application configuration, or other issues with the network.

Various aspects relate generally to UE resource-constrained states. Some aspects more specifically relate to handling QMC functions and QoE reporting while the UE is experiencing overheating or in a power saving mode. Some implementations described herein may handle telematics functions against UE thermal mitigation and power saving actions or mechanisms, which can impact the design of telematics functions and applications.

In some aspects, a UE that has entered a thermal-resource-constrained state or a power-resource-constrained state may request to deactivate (e.g., release, suspend, or the like) one or more QMC configurations for one or more applications. The UE May receive an indication to deactivate the one or more QMC configurations. In some examples, the application(s) indicated for QMC configuration deactivation may be low-priority. For example, the UE may indicate UE preferences to suspend QMC configurations (e.g., for non-critical QMC functions as configured by the network node) in a UAI message for thermal mitigation (e.g., while the UE is experiencing overheating) or for UE power saving (e.g., when the UE is in a power-saving mode).

Some aspects relate to including information regarding a UE overheating status (e.g., an indication that a UE is experiencing overheating) and/or a UE power saving mode (e.g., an indication that the UE is in a power saving mode) in a QoE report. In some examples, a UE that has entered a thermal-resource-constrained state or a power-resource-constrained state may transmit, in a QoE report container, an indication that the UE is in the thermal-resource-constrained state or the power-resource-constrained state. In some examples, the UE may obtain the QoE report container from a high-priority application. These aspects may, for example, apply to an NR QoE framework.

Particular aspects of the subject matter described in this disclosure can be implemented to realize one or more of the following potential advantages. In some examples, by transmitting a request to deactivate one or more QMC configurations for one or more applications, the described techniques can be used to manage QMC while a UE is in power saving mode or experiencing internal overheating. For example, the UE may receive an indication to deactivate the one or more QMC configurations, which may enable the UE to stop providing QoE reports for the one or more applications while the UE is in the power saving mode or experiencing internal overheating. The application(s) being low-priority may enable the UE to handle (e.g., intelligently suspend) non-critical tasks (e.g., QoE measurement) and message transmissions (e.g., QoE reporting) as configured by the network node when the UE is in the power saving mode or experiencing internal overheating. For example, the UE may continue to provide QoE reports for high-priority application(s).

In some examples, by transmitting an indication that the UE is in the thermal-resource-constrained state or the power-resource-constrained state in a QoE report container, the described techniques can be used to inform the OAM server (and/or the service provider, mobile network operator (MNO), original equipment manufacturer (OEM), or the like) that the decreased QoE may be due to power-saving or overheating mitigation actions taken by the UE. Thus, the OAM server (and/or other network entities) may accurately evaluate the cause of the end-user experience and take effective actions, and/or refrain from taking ineffective actions, to address the degradation of the application QoE against the UE thermal mitigation and power saving actions. Thus, the described techniques may enhance QoE reporting while the UE is in a power saving mode or experiencing internal overheating to include information regarding the underlying mitigation actions taken by the UE for services supporting a 3GPP QoE framework (e.g., dynamic adaptive streaming over hypertext transfer protocol (HTTP) (DASH), a multimedia telephony service over internet protocol (IP) multimedia subsystem (IMS) (MTSI), a multimedia broadcast/multicast service (MBMS), virtual reality (VR) services, or the like). Obtaining the QoE report container from a high-priority application may help to ensure that high-priority (e.g., critical) applications continue to provide QoE reports when the UE is in a power saving mode or experiencing internal overheating (e.g., while non-critical applications do not).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

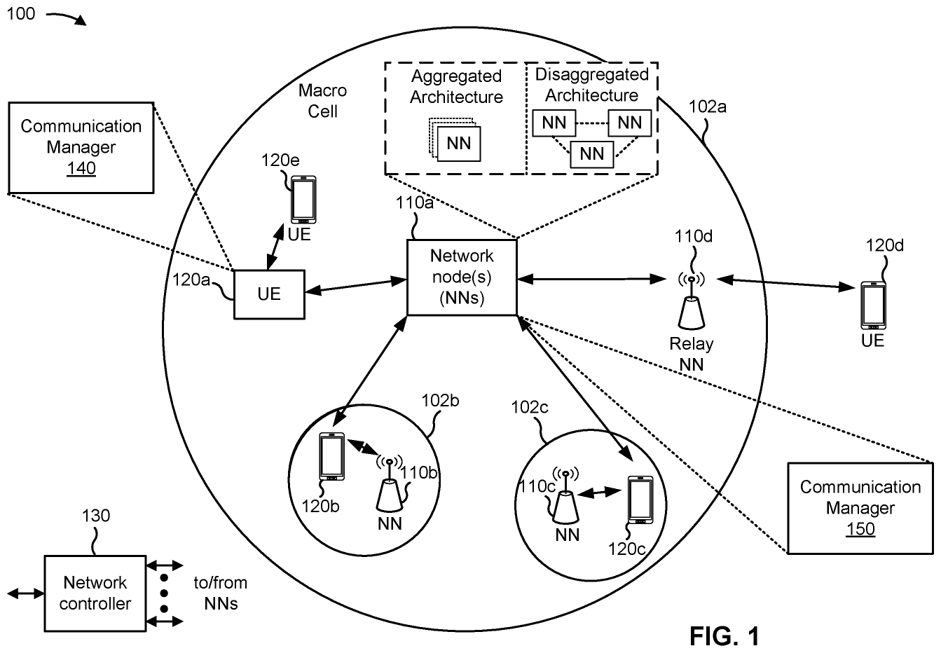

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, based at least in part on a thermal-resource-constrained state of the UE 120 or a power-resource-constrained state of the UE 120, a request to deactivate one or more QMC configurations for one or more applications; and receive an indication to deactivate the one or more QMC configurations. Additionally, or alternatively, the communication manager 140 may perform one or more other operations described herein.

As described in more detail elsewhere herein, the communication manager 140 may enter a thermal-resource-constrained state or a power-resource-constrained state; and transmit, in a QoE report container, an indication that the UE 120 is in the thermal-resource-constrained state or the power-resource-constrained state. Additionally, or alternatively, the communication manager 140 may perform one or more other operations described herein.

In some aspects, the network node 110 may include a communication manager 150. As described in more detail elsewhere herein, the communication manager 150 may obtain, based at least in part on a thermal-resource-constrained state of the UE 120 or a power-resource-constrained state of the UE 120, a request to deactivate one or more QMC configurations for one or more applications; and output an indication to deactivate the one or more QMC configurations. Additionally, or alternatively, the communication manager 150 may perform one or more other operations described herein.

As described in more detail elsewhere herein, the communication manager 150 may obtain, in a QoE report container, an indication that the UE 120 is in a thermal-resource-constrained state or a power-resource-constrained state; and output, in the QoE report container, to an OAM server, the indication that the UE 120 is in the thermal-resource-constrained state or the power-resource-constrained state. Additionally, or alternatively, the communication manager 150 may perform one or more other operations described herein.

As indicated above, FIG. 1 is provided as an example. Other examples may differ from what is described with regard to FIG. 1.

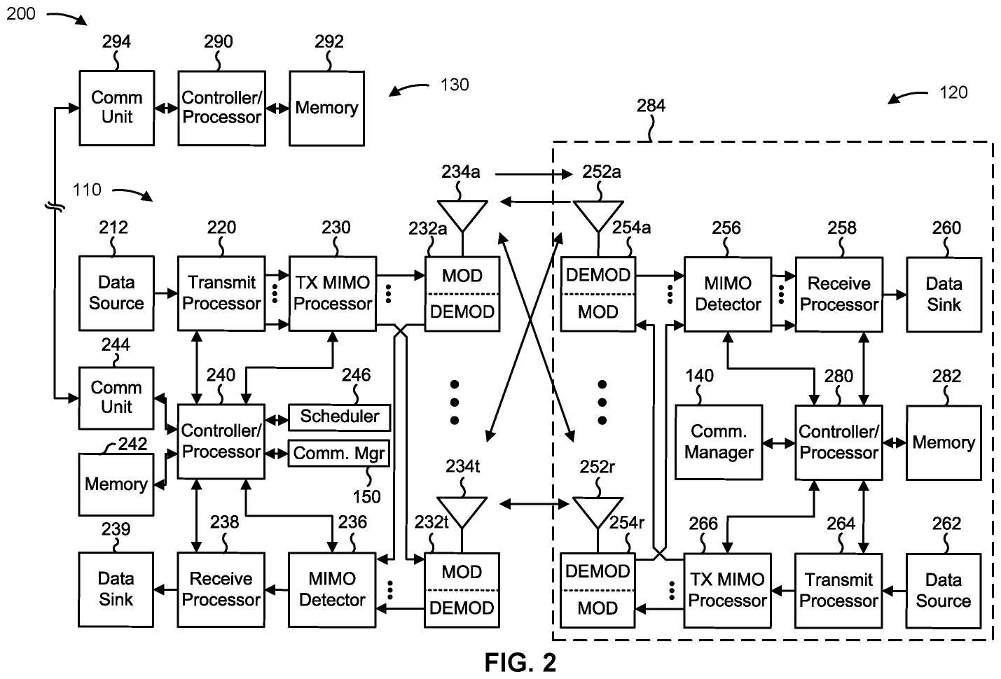

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

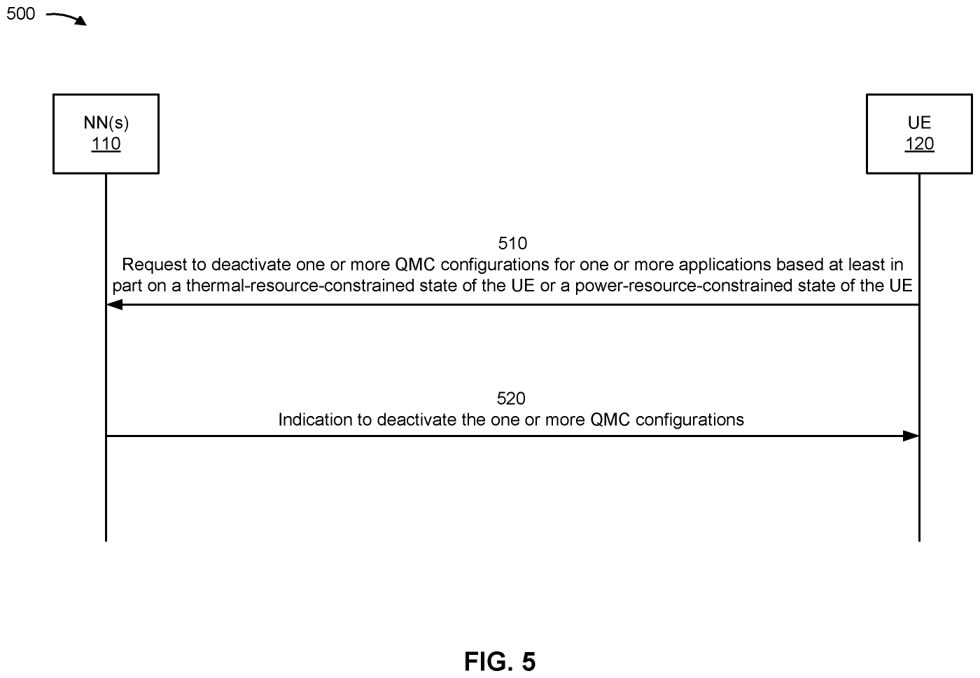

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5, 6A-6C, 7, 8, 9A-9C, and 10-20).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5, 6A-6C, 7, 8, 9A-9C, and 10-20).

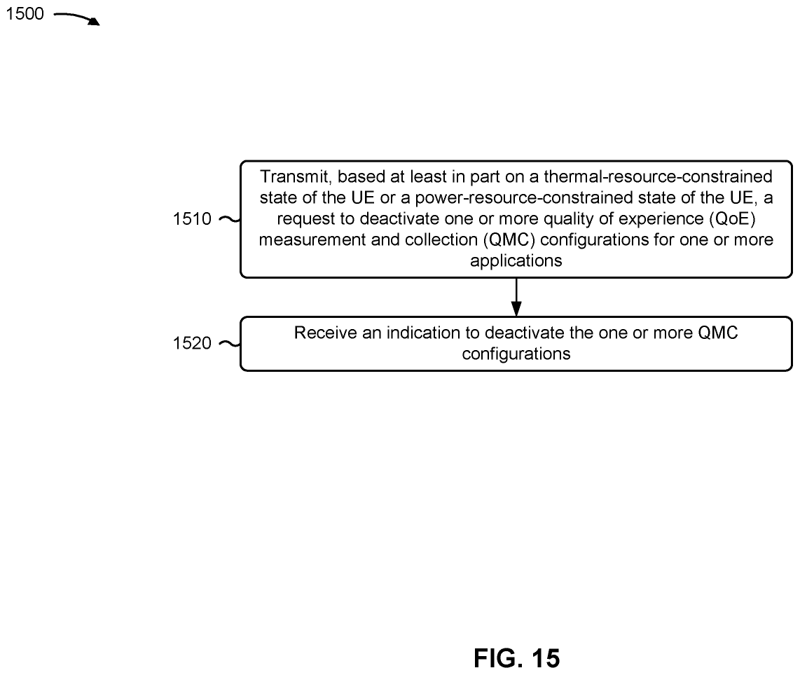

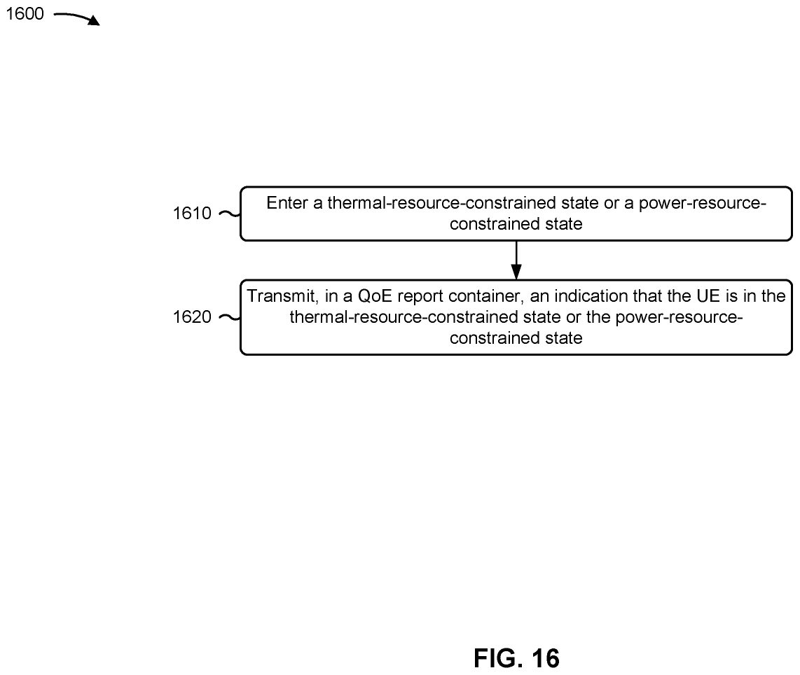

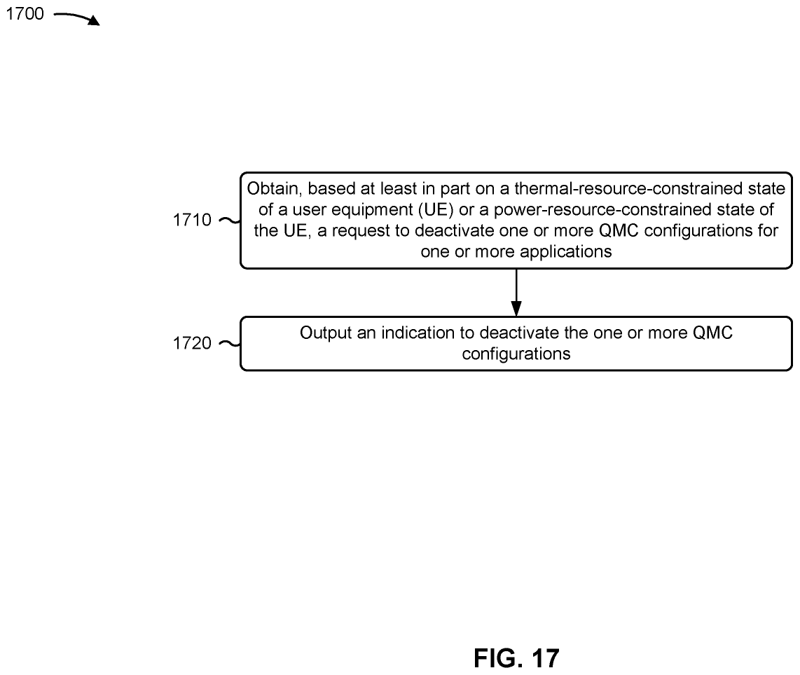

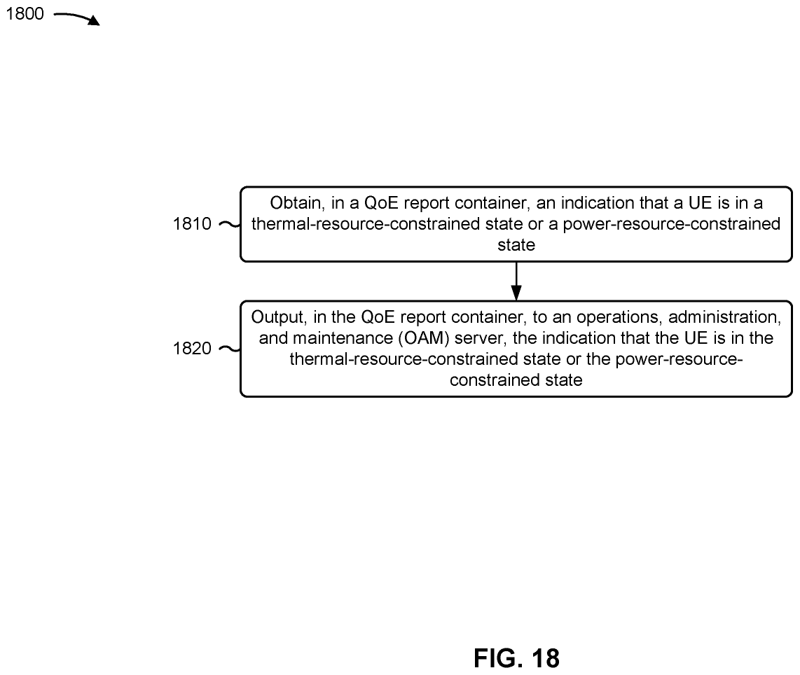

The controller/processor 240 of the network node 110, the controller/processor 280 of the UE 120, and/or any other component(s) of FIG. 2 may perform one or more techniques associated with handling a UE resource-constrained state, as described in more detail elsewhere herein. For example, the controller/processor 240 of the network node 110, the controller/processor 280 of the UE 120, and/or any other component(s) of FIG. 2 may perform or direct operations of, for example, process 1500 of FIG. 15, process 1600 of FIG. 16, process 1700 of FIG. 17, process 1800 of FIG. 18, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1500 of FIG. 15, process 1600 of FIG. 16, process 1700 of FIG. 17, process 1800 of FIG. 18, and/or other processes as described herein. In some examples, executing instructions may include running the instructions, converting the instructions, compiling the instructions, and/or interpreting the instructions, among other examples.

In some aspects, the UE 120 includes means for transmitting, based at least in part on a thermal-resource-constrained state of the UE 120 or a power-resource-constrained state of the UE 120, a request to deactivate one or more QMC configurations for one or more applications; and/or means for receiving an indication to deactivate the one or more QMC configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for entering a thermal-resource-constrained state or a power-resource-constrained state; and/or means for transmitting, in a QoE report container, an indication that the UE 120 is in the thermal-resource-constrained state or the power-resource-constrained state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining, based at least in part on a thermal-resource-constrained state of the UE 120 or a power-resource-constrained state of the UE 120, a request to deactivate one or more QMC configurations for one or more applications; and/or means for outputting an indication to deactivate the one or more QMC configurations. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node 110 includes means for obtaining, in a QoE report container, an indication that the UE 120 is in a thermal-resource-constrained state or a power-resource-constrained state; and/or means for outputting, in the QoE report container, to an OAM server, the indication that the UE 120 is in the thermal-resource-constrained state or the power-resource-constrained state. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

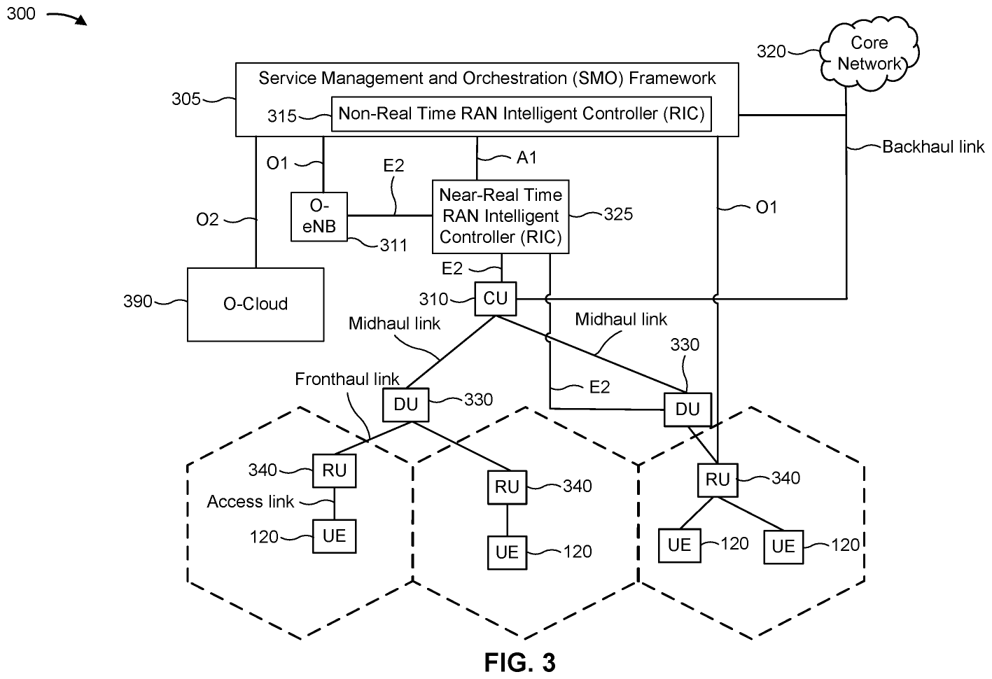

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

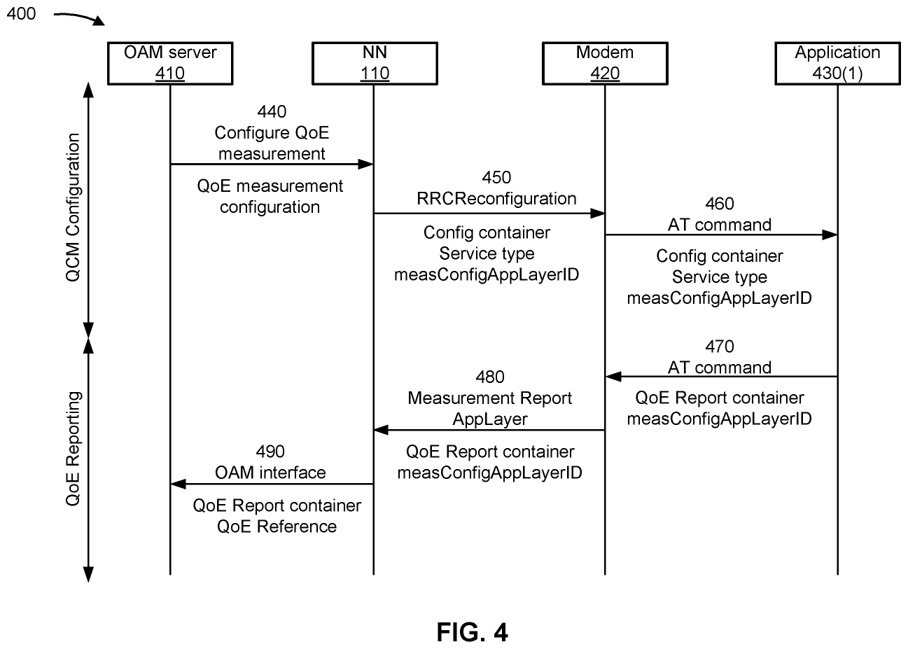

FIG. 4 is a diagram illustrating an example 400 of QMC, in accordance with the present disclosure. QMC (e.g., NR QMC) is a framework or function that enables collection of application layer measurement from a UE for certain service types, such as VR. DASH, MBMS, or the like.

Example 400 involves QMC-related interactions between an OAM server 410, a network node 110, a modem 420, and an application 430. The modem 420 and the application 430 may be hardware and/or software components of a UE, such as the UE 120. The OAM server 410 may be configured to manage one or more QMC configurations for the application 430 and/or other applications.

As shown by reference number 440, the OAM server 410 provides, and the network node 110 obtains, a QMC configuration (e.g., a configuration of one or more QoE measurements). The OAM server 410 may provide the indication to the network node 110 via a core network (e.g., a 5G core network) or directly to the network node 110. As shown by reference number 450, the network node 110 may output, and the modem 420 may receive, an RRC message (e.g., an RRC reconfiguration) based on the QMC configuration. As shown by reference number 460, the UE 120 may provide, from the modem 420 to the application 430, an attention (AT) command that configures the application based on the QMC configuration.

As shown by reference number 470, the UE 120 provides, from the application 430 to the modem 420, an AT command that includes a QoE report container. The QoE report container may include one or more QoE measurements in accordance with the QMC configuration. As shown by reference number 480, the modem 420 may transmit, and the network node 110 may obtain, an RRC message (e.g., a measurement report) based on the QoE report container. As shown by reference number 490, the network node 110 may output via an OAM interface, and the OAM server 410 may obtain, the QoE report container.

As indicated above, FIG. 4 is provided as an example. Other examples may differ from what is described with respect to FIG. 4.

UEs can enter a thermal-resource-constrained state (e.g., when the UE is experiencing overheating) and/or a power-resource-constrained state (e.g., when the UE is low on power, such as when the power falls below a power threshold). When in a thermal-resource-constrained state or a power-resource-constrained state, the UE may implement one or more thermal-mitigation mechanisms or power-saving mechanisms, which may enable the UE to satisfy a temperature or power threshold and, thus, exit the thermal-resource-constrained state or the power-resource-constrained state.

Vehicular UEs, for example, are becoming increasingly vulnerable to heat and sun exposure and, therefore, susceptible to overheating due to vehicular UEs approaching roof-mounted telematics control unit (TCU) designs. Some power optimization strategies that support automotive use cases are available for vehicular UEs (e.g., UE standby power optimization for command/control delivery during parked vehicle scenarios).

In 5G NR, a UE may indicate, to a network node, UE preferences regarding mitigation actions for UE overheating and/or power saving. However, no mechanisms exist within the NR QoE and UAI frameworks that enable the UE to indicate a preference for suspension of QMC configurations for the purposes of thermal mitigation and/or power saving. As a result, a UE may continue to report QoE measurements (e.g., for non-critical applications), in accordance with a QMC configuration, after entering a thermal-resource-constrained state and/or a power-resource-constrained state. Reporting QoE measurements in a thermal-resource-constrained state may extend the length of time during which the UE remains in the thermal-resource-constrained state and/or may raise the internal temperature of the UE. Reporting QoE measurements in a power-resource-constrained state may cause the UE to lose power faster than the UE would if the UE were not configured to report the QoE measurements during the power-resource-constrained state.

Furthermore, the UE may implement certain mitigation actions or strategies for overheating and power saving, such as lowering central processing unit (CPU) utilization, modem configuration, or the like. These mitigation actions can decrease QoE (e.g., by degrading vehicular UE performance and impacting telematics and in-vehicle infotainment applications) but are not reported to the OAM server. As a result, upon obtaining a QoE report that indicates the decreased QoE, in accordance with the 3GPP NR QoE framework, the OAM server may initiate ineffective QoE improvement actions, such as prompting the network node to adjust network resources and/or prompting the application server to customize application configurations to improve the overall user experience (e.g., the QoE). These QoE improvement actions are ineffective because the decreased QoE is due to the mitigation actions performed by the UE, rather than due to inadequate network resources, application configuration, or other issues with the network.

For example, a UE in a power-resource-constrained state may lower CPU utilization for power savings. As a result, a media streaming client on the UE may experience a high buffer level (or media playback stalling due to buffer under-run). The UE many provide a QoE report that indicates high buffer levels at the client side but not the corresponding UE power saving mitigation action (e.g., decreased CPU utilization). The application server may lower the video resolution and/or the network node may assign more network resources to the UE. However, because the UE power saving mitigation action is the cause of the high buffer levels, the adjustments by the application server and/or network node do not improve the QoE, and may involve application server computational units and/or network resources that could be allocated for other uses.

FIG. 5 is a diagram illustrating an example 500 associated with deactivation of one or more QMC configurations based on a UE resource-constrained state, in accordance with the present disclosure. As shown in FIG. 5, a network node 110 and a UE 120 (e.g., a vehicular UE) may communicate with one another.

As shown by reference number 510, the UE 120 may transmit, and the network node 110 may obtain, based at least in part on a thermal-resource-constrained state of the UE 120 or a power-resource-constrained state of the UE 120, a request to deactivate one or more QMC configurations for one or more applications. For example, the UE 120 may transmit the request in response to entering the thermal-resource-constrained state or the power-resource-constrained state.

The thermal-resource-constrained state may be an overheating state of the UE 120 (e.g., a state in which the UE 120 is experiencing internal overheating, such as a state during which an internal temperature of the UE 120 exceeds a threshold). The power-resource-constrained state may be a power-saving state of the UE 120 (e.g., a state in which the UE 120 is experiencing low power, such as a state during which an amount of power stored on one or more batteries of the UE 120 is below a threshold). A QMC configuration for an application may be a configuration for the UE to conduct one or more QoE-related measurements for the application and report the QoE-related measurement(s) (e.g., in one or more QoE report containers).

As shown by reference number 520, the network node 110 may output, and the UE 120 may receive, an indication to deactivate the one or more QMC configurations. In some examples, based on the indication, the UE 120 may deactivate the one or more QMC configurations (e.g., while the UE 120 remains in the thermal-resource-constrained state or the power-resource-constrained state).

Transmitting the request to deactivate the QMC configuration(s) based at least in part on the thermal-resource-constrained state or the power-resource-constrained state may enable the UE 120 to cease reporting QoE measurements while the UE 120 remains in the thermal-resource-constrained state or the power-resource-constrained state. As a result, in case the UE 120 is in the thermal-resource-constrained state, the UE 120 may exit the thermal-resource-constrained state (e.g., an internal temperature of the UE 120 may fall below a threshold) faster than the UE would take to exit the thermal-resource-constrained state if the UE 120 were continuing to report the QoE measurements during the thermal-resource-constrained state. In case the UE 120 is in the power-resource-constrained state, the UE 120 may conserve the limited power stored in one or more UE batteries for a longer period of time than the UE 120 would conserve the limited power if the UE 120 were continuing to report the QoE measurements during the power-resource-constrained state.

As indicated above, FIG. 5 is provided as an example. Other examples may differ from what is described with respect to FIG. 5.

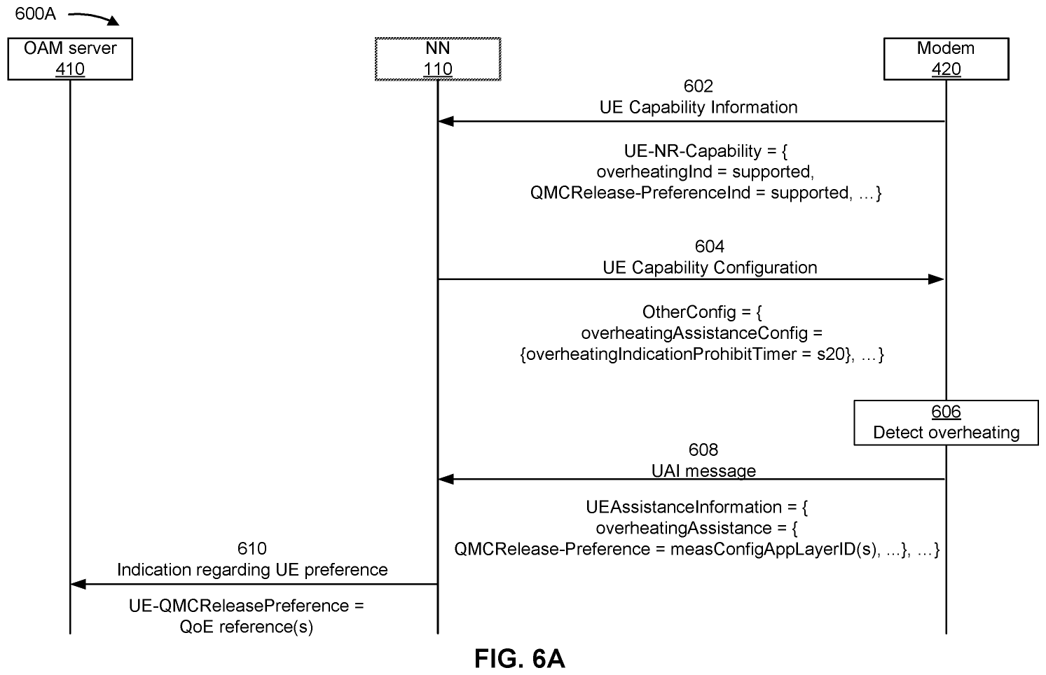

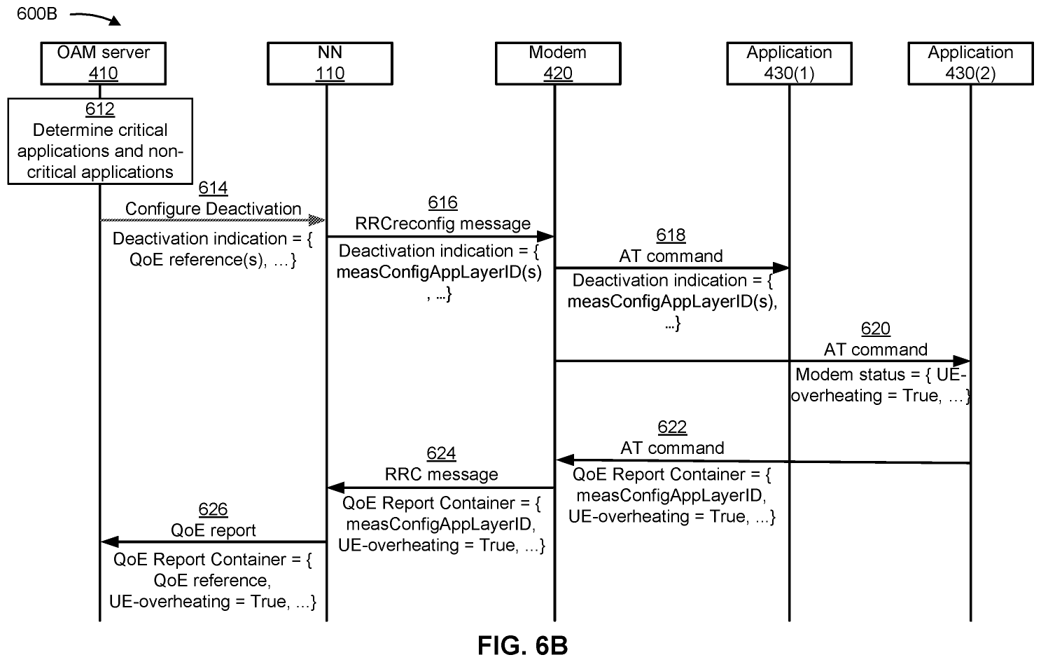

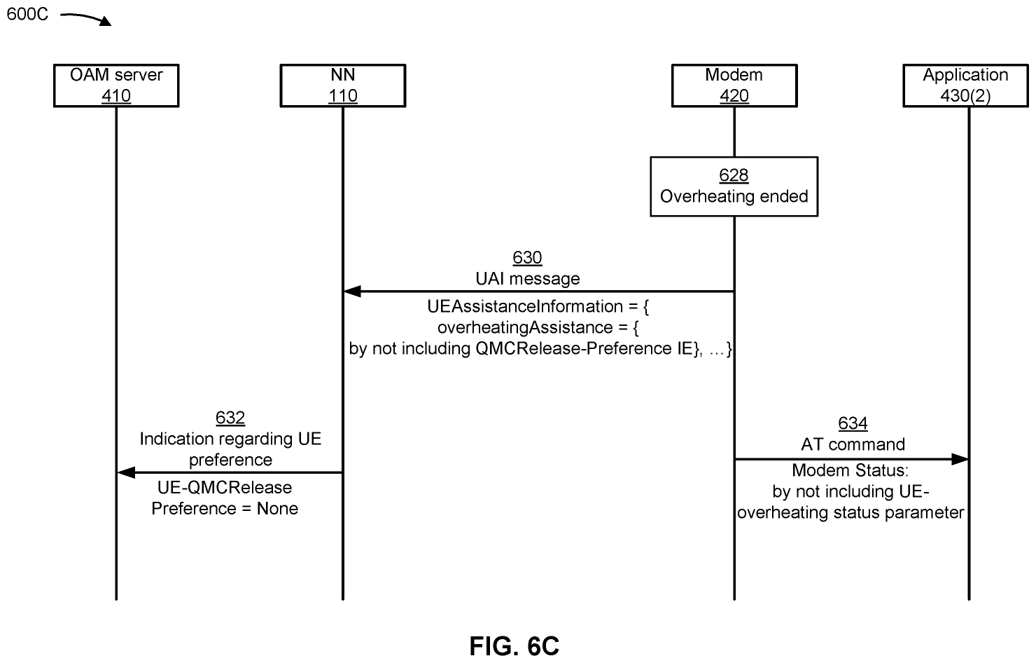

FIGS. 6A-6C are diagrams illustrating examples 600A-600C associated with signaling for handling a UE thermal-resource-constrained state, in accordance with the present disclosure. The signaling may occur between the OAM server 410, the network node 110, the modem 420, and applications 430(1) and 430(2). The modem 420 and applications 430(1) and 430(2) may be located on the UE 120. The UE 120 may be in an RRC connected state, capable of sending UAI messages to address overheating situations, and configured by the network node 110 to indicate a UE preference upon detecting internal overheating (e.g., upon the UE entering the thermal-resource-constrained state) and/or upon an overheating condition ending (e.g., upon the UE exiting the thermal-resource-constrained state).

With reference to FIG. 6A, as shown by reference number 602, the modem 420 may transmit, and the network node 110 may obtain, capability information including an indication that the UE 120 is capable of transmitting a request to deactivate QMC configurations for applications. For example, the indication may be provided by the QMCRelease-PreferenceInd parameter being set to “supported.” The capability information may inform the network node 110 that the UE 120 is capable of transmitting a request to deactivate the QMC configurations.

As shown by reference number 604, the network node 110 may output, and the modem 420 may receive, a configuration that configures the UE 120 to transmit the request to deactivate QMC configurations upon the UE 120 entering a thermal-resource-constrained state. The configuration may include a configuration of a timer configured to start based at least in part on the UE entering the thermal-resource-constrained state.

As shown by reference number 606, the UE 120 detects an overheating occurrence. For example, the UE 120 may detect an internal temperature of the UE 120 that is greater than a threshold. Thus, the UE 120 may enter the thermal-resource-constrained state.

As shown by reference number 608, the modem 420 may transmit, and the network node 110 may obtain, based at least in part on the thermal-resource-constrained state of the UE 120, a request to deactivate a plurality of QMC configurations for a plurality of applications. For example, the modem 420 may transmit the request to deactivate the QMC configurations based at least in part on the timer expiring. Transmitting the request to deactivate the QMC configurations based at least in part on the timer expiring may help to ensure that the thermal-resource-constrained state persists for a sufficient amount of time (e.g., beyond the length of the timer) and, thus, that allocation of resources for deactivating the QMC configuration is warranted.

The QMC configurations may configure the UE 120 to provide QoE reporting for the applications. Thus, the request to deactivate the QMC configurations may be a request to cease (e.g., temporarily cease) providing the QoE reporting for the applications while the UE remains in the thermal-resource-constrained state. In some examples, the modem 420 may transmit a UAI message that contains the request to deactivate the QMC configurations.

In some examples, the request to deactivate the QMC configurations includes application layer identifiers (e.g., “measConfigAppLayerID(s)”) corresponding to the applications. For example, the request to deactivate the QMC configurations may include application layer identifiers corresponding to respective applications. The application layer identifiers in the request to deactivate the QMC configurations may indicate which applications the UE 120 is requesting to deactivate QMC configurations for.

As shown by reference number 610, the network node 110 may output, to the OAM server 410, the request to deactivate the QMC configurations. For example, the network node 110 may output the request via an OAM interface. For example, the network node 110 may determine the UE preference to deactivate the QMC configurations based on a change in a value of the QMCRelease-Preference field in the overheatingAssistance information element (IE). Outputting the request to deactivate the QMC configurations to the OAM server 410 may enable the OAM server 410 to reconfigure the QMC configurations for one or more of the applications.

With reference to FIG. 6B, as shown by reference number 612, the OAM server 410 determines which of the applications (indicated in the request to deactivate the QMC configurations) are critical and which of the applications are non-critical. Critical applications may be high-priority applications for which QoE measurement and reporting should continue during the thermal-resource-constrained state. Non-critical applications may be lower-priority applications for which QoE measurement and reporting may cease during the thermal-resource-constrained state. The OAM server 410 may determine which applications are critical and which applications are non-critical based on the UE preference and/or QoE configuration priorities for the applications. In this example, the OAM server 410 determines that application 430(1) is non-critical and application 430(2) is critical.

Determining which application(s) are low-priority and which application(s) are high-priority may enable the UE 120 to handle the low-priority applications and high-priority applications differently during the thermal-resource-constrained state. For example, ceasing QoE reporting for the low-priority applications and continuing QoE reporting for the high-priority applications when the UE is in the thermal-resource-constrained state may help to mitigate overheating while ensuring that the QoE of the high-priority applications continue to be monitored.

As shown by reference number 614, the network node 110 obtains, from the OAM server 410, an indication to deactivate one or more QMC configurations. For example, the network node 110 may obtain an indication to deactivate a QMC configuration for the application 430(1). Obtaining the indication to deactivate the QMC configuration(s) may enable the network node 110 to indicate to the UE 120 which QMC configuration(s) to deactivate.

As shown by reference number 616, the network node 110 may output, and the modem 420 may receive, the indication to deactivate one or more QMC configurations (e.g., the QMC configuration for the application 430(1). The indication may be an RRCreconfig message that configures the UE 120 to deactivate one or more existing QoE measurement configurations and pause QoE measurement and reporting for applications determined by the OAM server 410 to be non-critical. The network node 110 may determine which applications are non-critical based on the QMC identifier(s) included in a QoE reference parameter provided by the OAM server 410 in the indication to deactivate the QMC configuration(s) (as shown by reference number 614).

In some examples, the indication to deactivate the one or more QMC configurations includes one or more application layer identifiers (e.g., the application layer identifier corresponding to the application 430(1)). The application layer identifiers in the indication to deactivate the QMC configuration(s) may indicate which applications the UE 120 is to deactivate QMC configurations for.

As shown by reference number 618, the modem 420 may provide, to application 430(1), an indication to deactivate the QMC configuration for the application 430(1). For example, upon receiving the QMC deactivation configuration as shown by reference number 616, the RRC layer of the UE 120 may inform the application 430(1) (which is low-priority and, thus, not configured by the OAM server 410 to continue QoE measurement and reporting while the UE 120 is experiencing overheating) to deactivate the QMC configuration for application 430(1) and cease QoE measurement and reporting. Based on the indication, the application 430(1) may cease providing QoE reports.

As shown by reference number 620, the modem 420 may provide a command (e.g., an AT command), to application 430(2), to generate, during the thermal-resource-constrained state, one or more QoE report containers. The command may depend on a UE-specific implementation. For example, the AT command may include a UE-overheating parameter, which, when set to “true,” may indicate that the UE 120 is in the thermal-resource-constrained state. The application 430(2) is high-priority and, thus, configured to continue QoE measurement and reporting during the thermal-resource-constrained state (e.g., while one or more UE overheating conditions, such as an internal temperature of the UE 120 exceeding a threshold, remain satisfied).

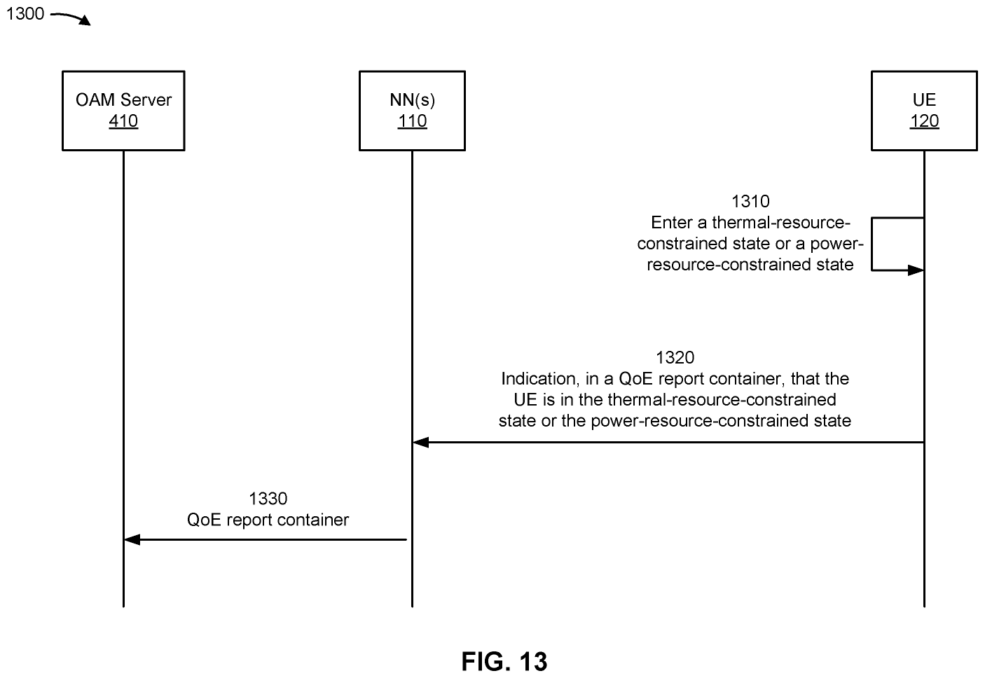

As shown by reference number 622, the modem 420 may obtain, from the application 430(2), a QoE report container that includes an indication that the UE is in the thermal-resource-constrained state. The application 430(2) may include, in the QoE report container, the UE-overheating parameter set to “true.” As shown by reference number 624, the modem 420 may transmit, and the network node 110 may obtain, the QoE report container. As shown by reference number 626, the network node 110 may output, to the OAM server 410, the QoE report container. Operations associated with reference numbers 620-626 are described in greater detail below with respect to FIG. 13.

With reference to FIG. 6C, as shown by reference number 628, the UE 120 determines that the overheating occurrence has ended. For example, the UE 120 may detect an internal temperature of the UE 120 that is less than a threshold. Thus, the UE 120 may exit the thermal-resource-constrained state.

As shown by reference number 630, the UE 120 may transmit, and the network node 110 may obtain, an indication that the UE 120 has exited the thermal-resource-constrained state. For example, the UE 120 may transmit a UAI message that contains the indication that the UE 120 has exited the thermal-resource-constrained state. For example, the UAI message may exclude the QMCRelease-Preference IE. The network node 110 obtaining the indication that the UE 120 has exited the thermal-resource-constrained state may enable the network node 110 to inform the OAM server 410 that the UE 120 has exited the thermal-resource-constrained state.

As shown by reference number 632, the network node 110 may output (e.g., forward), to the OAM server 410, the indication that the UE 120 has exited the thermal-resource-constrained state. For example, the network node 110 may determine that the UAI message implicitly indicates that the UE 120 is no longer experiencing an overheating situation based on the change in the UAI message (e.g., based on the absence of the QMCRelease-Preference IE) and, thus, that the UE preference to deactivate the QMC configurations has ended. The indication that the UE 120 has exited the thermal-resource-constrained state may include a QoE reference parameter. The indication may inform the OAM server 410 that the UE 120 has exited the thermal-resource-constrained state.

As shown by reference number 634, the modem 420 may provide, to the application 430(2), an indication (e.g., an AT command) that the UE 120 has exited the thermal-resource-constrained state. The indication may depend on a UE-specific implementation. For example, the application 430(2) may determine that the AT command implicitly indicates that the UE 120 is no longer experiencing an overheating situation based on an absence of the UE-overheating parameter in the AT command. The indication that the UE 120 has exited the thermal-resource-constrained state may prompt the application 430(2) to cease including the UE-overheating parameter in QoE report containers (e.g., the QoE report containers may no longer indicate that the UE 120 is in the thermal-resource-constrained state).

Examples 600A-600C are provided for management-based QoE configuration (e.g., where the OAM server 410 sends a QoE activation/deactivation configuration to the network node 110 directly). Implementations provided herein may also or alternatively apply to signaling-based QoE activation/deactivation (e.g., where the OAM server 410 sends the configurations to the network node 110 via a core network, such as a 5G core network). In some examples, the signaling provided in examples 600A-600C can be used in master node (MN)/secondary node (SN) implementations (e.g., in master cell group (MCG)/secondary cell group (SCG) implementations) in NR dual connectivity (NR-DC) scenarios.

As indicated above, FIG. 6 is provided as an example. Other examples may differ from what is described with respect to FIG. 6.

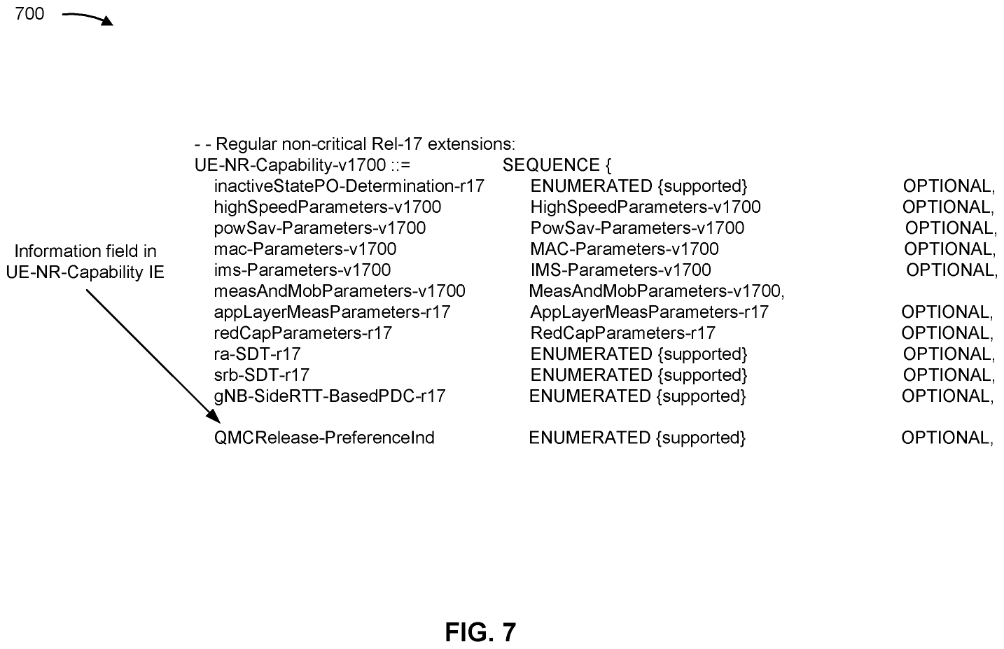

FIG. 7 is a diagram illustrating an example 700 of capability information including an indication that the UE 120 is capable of transmitting a request to deactivate QMC configurations for applications for a thermal-resource-constrained state, in accordance with the present disclosure.

Example 700 shows an information field that may be transmitted by the UE 120 and obtained by the network node 110 (e.g., as shown by reference number 602 in FIG. 6). For example, the QMCRelease-PreferenceInd parameter in the UE-NR-Capability field may indicate whether the UE 120 supports indicating a UE preference to deactivate QMC configurations during overheating situations. Table 1 below provides information relating to the QMCRelease-PreferenceInd parameter.

TABLE 1

| | | | Frequency division | |
|---|---|---|---|---|
| | | | duplexing - time- | FR1-FR2 |
| | | | division duplexing | difference |
| | | | difference (FDD- | FR1-FR2 |
| Definitions of Parameter | Per | M | TDD DIFF) | DIFF) |
| QMCRelease-PreferenceInd | UE | No | No | No |
| identifies whether the UE | | | | |
| supports indication of its | | | | |
| preference to release QMC | | | | |
| configurations during | | | | |
| overheating and power saving. | | | | |

As indicated above, FIG. 7 is provided as an example. Other examples may differ from what is described with respect to FIG. 7.

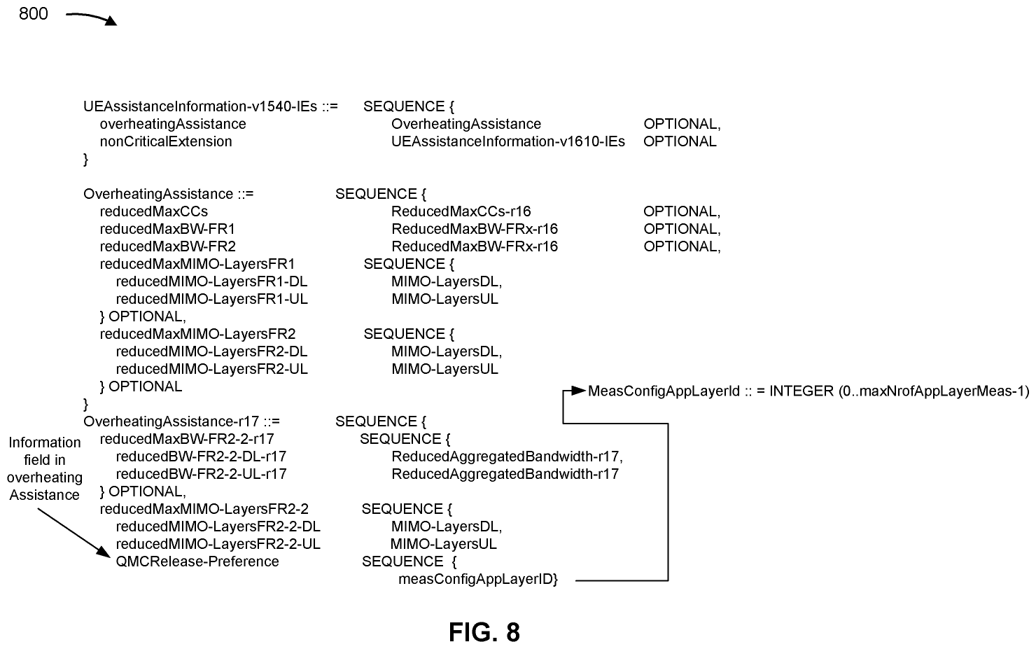

FIG. 8 is a diagram illustrating an example 800 of a UAI message that contains the request to deactivate one or more QMC configurations, in accordance with the present disclosure.

Example 800 shows an information field that may be transmitted by the UE 120 and obtained by the network node 110 (e.g., as shown by reference number 608 in FIG. 6). For example, the field QMCRelease-Preference in the overheatingAssistance IE may permit the UE 120 to indicate a UE preference to deactivate QMC configurations during overheating situations (if the UE 120 has been configured to indicate the UE preference, e.g., as shown by reference number 604 in FIG. 6). The QMCRelease-Preference field being absent from the overheatingAssistance IE may indicate that the UE 120 has no preference regarding QoE measurement and reporting for applications of the UE 120 (e.g., the UE 120 is not requesting to deactivate the QMC configurations for the applications). The measConfigAppLayerID may identify one QMC configuration between the UE 120 and the network node 110. For example, the UE 120 may use the measConfigAppLayerID to identify the QMC configurations that the UE 120 requests to release.

As indicated above, FIG. 8 is provided as an example. Other examples may differ from what is described with respect to FIG. 8.

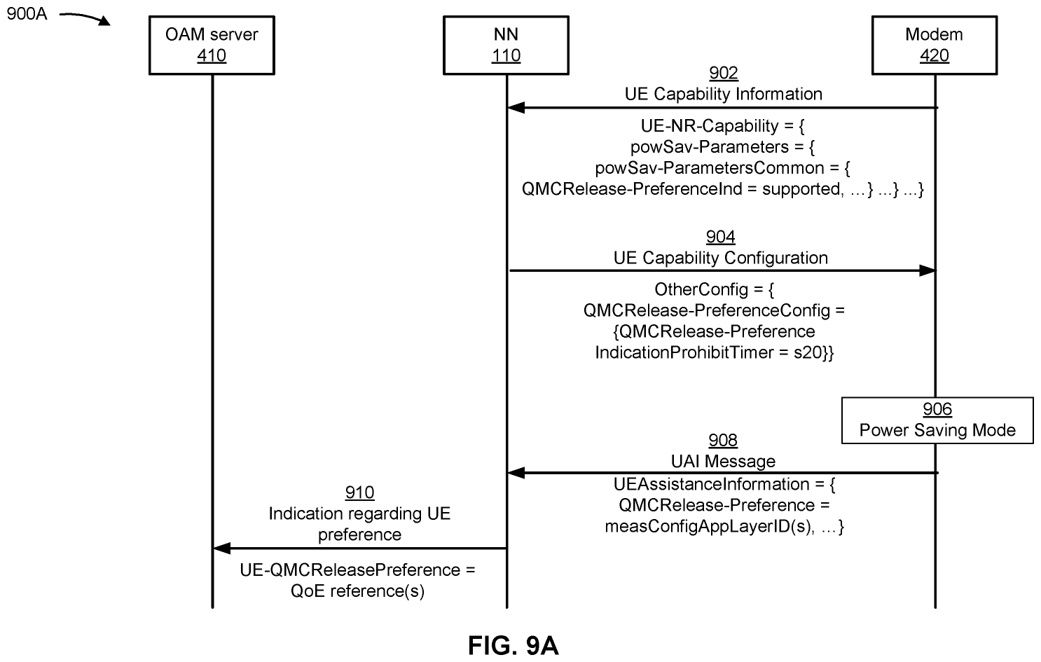

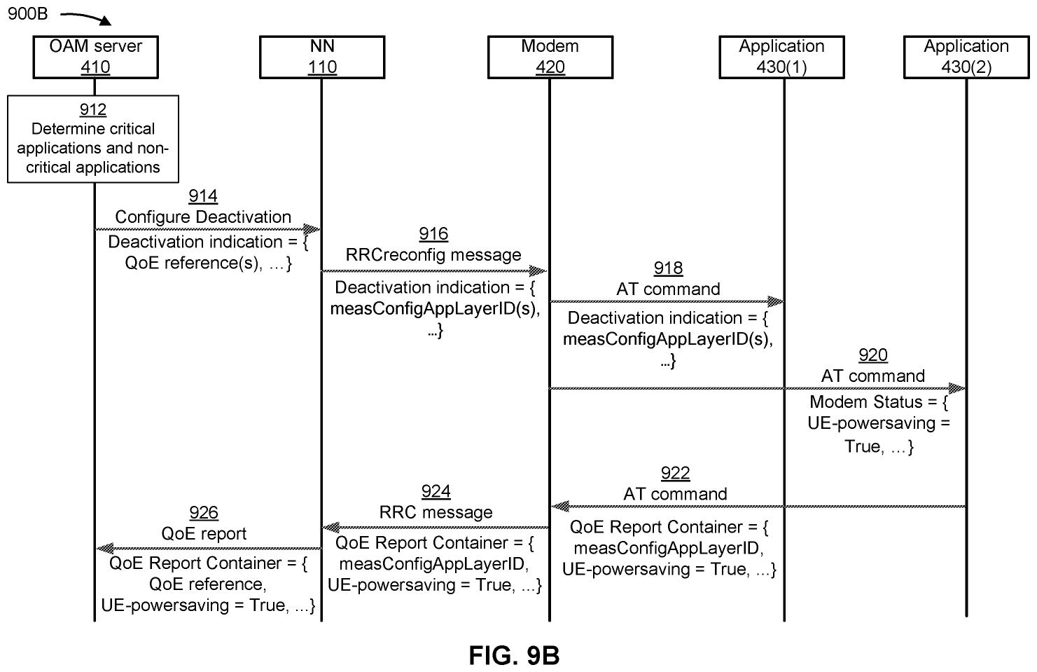

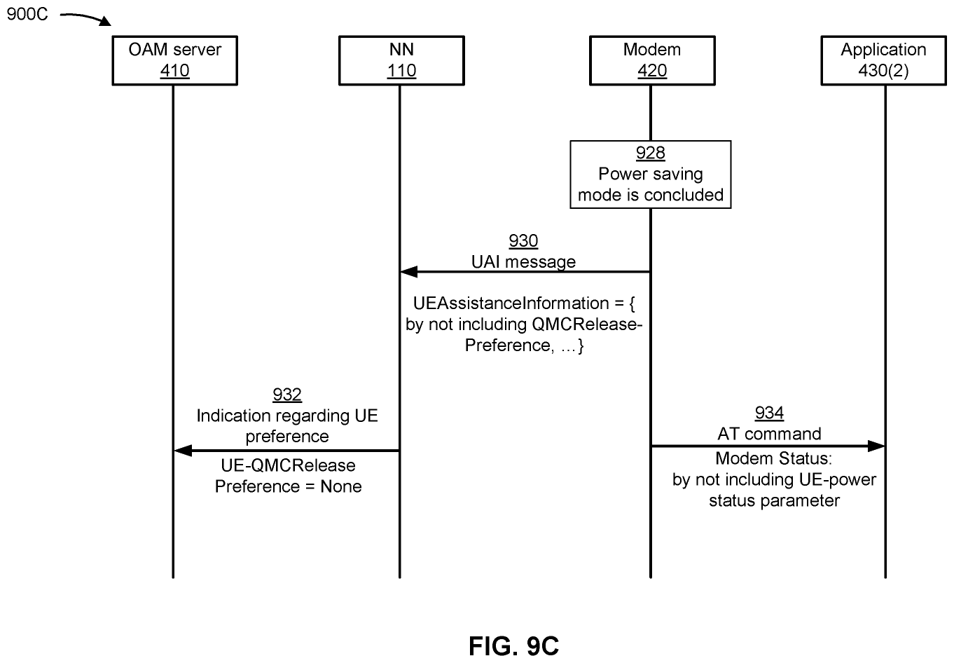

FIGS. 9A-9C are diagrams illustrating examples 900A-900C associated with signaling for handling a UE power-resource-constrained state, in accordance with the present disclosure. The signaling may occur between the OAM server 410, the network node 110, the modem 420, and applications 430(1) and 430(2). The UE 120 may be in an RRC connected state, capable of sending UAI messages for UE power saving, and configured by the network node 110 to indicate a UE preference to address a UE power-saving situation (e.g., upon the UE entering or exiting the power-resource-constrained state).

With reference to FIG. 9A, as shown by reference number 902, the modem 420 may transmit, and the network node 110 may obtain, capability information including an indication that the UE 120 is capable of transmitting a request to deactivate QMC configurations for applications. For example, the indication may be provided by the QMCRelease-PreferenceInd parameter being set to “supported.” The capability information may inform the network node 110 that the UE 120 is capable of transmitting a request to deactivate the QMC configurations.

As shown by reference number 904, the network node 110 may output, and the modem 420 may receive, a configuration that configures the UE 120 to transmit the request to deactivate QMC configurations upon the UE 120 entering a power-resource-constrained state. The configuration may include a configuration of a timer configured to start based at least in part on the UE entering the power-resource-constrained state.

As shown by reference number 906, the UE 120 enters a power-saving mode. For example, the UE 120 may detect that a stored energy level of the UE 120 has fallen below than a threshold. Thus, the UE 120 may enter the power-resource-constrained state (e.g., the power-saving mode).

As shown by reference number 908, the modem 420 may transmit, and the network node 110 may obtain, based at least in part on the power-resource-constrained state of the UE 120, a request to deactivate a plurality of QMC configurations for a plurality of applications. For example, the modem 420 may transmit the request to deactivate the QMC configurations based at least in part on the timer expiring. Transmitting the request to deactivate the QMC configurations based at least in part on the timer expiring may help to ensure that the power-resource-constrained state persists for a sufficient amount of time (e.g., beyond the length of the timer) and, thus, that allocation of resources for deactivating the QMC configuration is warranted.

The QMC configurations may configure the UE 120 to provide QoE reporting for the applications. Thus, the request to deactivate the QMC configurations may be a request to cease (e.g., temporarily cease) providing the QoE reporting for the applications while the UE remains in the power-resource-constrained state. In some examples, the modem 420 may transmit a UAI message that contains the request to deactivate the QMC configurations.

In some examples, the request to deactivate the QMC configurations includes application layer identifiers (e.g., “measConfigAppLayerID(s)”) corresponding to the applications. For example, the request to deactivate the QMC configurations may include application layer identifiers corresponding to respective applications. The application layer identifiers in the request to deactivate the QMC configurations may indicate which applications the UE 120 is requesting to deactivate QMC configurations for.

As shown by reference number 910, the network node 110 may output, to the OAM server 410, the request to deactivate the QMC configurations. For example, the network node 110 may output the request via an OAM interface. For example, the network node 110 may determine the UE preference to deactivate the QMC configurations based on a change in a value of the QMCRelease-Preference field. Outputting the request to deactivate the QMC configurations to the OAM server 410 may enable the OAM server 410 to reconfigure the QMC configurations for one or more of the applications.

With reference to FIG. 9B, as shown by reference number 912, the OAM server 410 determines which of the applications indicated in the request to deactivate the QMC configurations are critical and which of the applications are non-critical. Critical applications may be high-priority applications for which QoE measurement and reporting should continue during the power-resource-constrained state. Non-critical applications may be lower-priority applications for which QoE measurement and reporting may cease during the power-resource-constrained state. The OAM server 410 may determine which applications are critical and which applications are non-critical based on the UE preference and/or QoE configuration priorities for the applications. In this example, the OAM server 410 determines that application 430(1) is non-critical and application 430(2) is critical.

Determining which application(s) are low-priority and which application(s) are high-priority may enable the UE 120 to handle the low-priority applications and high-priority applications differently during the power-resource-constrained state. For example, ceasing QoE reporting for the low-priority applications and continuing QoE reporting for the high-priority applications when the UE is in the power-resource-constrained state may help to conserve power while ensuring that the QoE of the high-priority applications continue to be monitored.

As shown by reference number 914, the network node 110 obtains, from the OAM server 410, an indication to deactivate one or more QMC configurations. For example, the network node 110 may obtain an indication to deactivate a QMC configuration for the application 430(1). Obtaining the indication to deactivate the QMC configuration(s) may enable the network node 110 to indicate to the UE 120 which QMC configuration(s) to deactivate.

As shown by reference number 916, the network node 110 may output, and the modem 420 may receive, the indication to deactivate one or more QMC configurations (e.g., the QMC configuration for the application 430(1). The indication may be an RRCreconfig message that configures the UE 120 to deactivate one or more existing QoE measurement configurations and pause QoE measurement and reporting for applications by the OAM server 410 to be non-critical. The network node 110 may determine which applications are non-critical based on the QMC identifier(s) included in a QoE reference parameter provided by the OAM server 410 in the indication to deactivate the QMC configuration(s) (as shown by reference number 914).

In some examples, the indication to deactivate the one or more QMC configurations includes one or more application layer identifiers (e.g., the application layer identifier corresponding to the application 430(1)). Including the application layer identifiers in the indication to deactivate the QMC configuration(s) may indicate which applications the UE 120 is to deactivate QMC configurations for.

As shown by reference number 918, the modem 420 may provide, to application 430(1), an indication to deactivate the QMC configuration for the application 430(1). For example, upon receiving the QMC deactivation configuration as shown by reference number 916, the RRC layer of the UE 120 may inform the application 430(1) (which is low-priority and, thus, not configured by the OAM server 410 to continue QoE measurement and reporting while the UE 120 is in the power-saving mode) to deactivate the QMC configuration for application 430(1) and cease QoE measurement and reporting. Based on the indication, the application 430(1) may cease providing QoE reports.

As shown by reference number 920, the modem 420 may provide a command (e.g., an AT command), to application 430(2), to generate, during the power-resource-constrained state, one or more QoE report containers. The command may depend on a UE-specific implementation. For example, the AT command may include a UE-powersaving parameter, which, when set to “true,” may indicate that the UE 120 is in the power-resource-constrained state. The application 430(2) is high-priority and, thus, configured to continue QoE measurement and reporting during the power-resource-constrained state.

As shown by reference number 922, the modem 420 may obtain, from the application 430(2), a QoE report container that includes an indication that the UE is in the power-resource-constrained state. The application 430(2) may include, in the QoE report container, the UE-powersaving parameter set to “true.” As shown by reference number 924, the modem 420 may transmit, and the network node 110 may obtain, the QoE report container. As shown by reference number 926, the network node 110 may output, to the OAM server 410, the QoE report container. Operations associated with reference numbers 920-926 are described in greater detail below with respect to FIG. 13.

With reference to FIG. 9C, as shown by reference number 928, the UE 120 determines that the power-saving mode has concluded. For example, the UE 120 may determine that a stored battery power level of the UE 120 is greater than a threshold. Thus, the UE 120 may exit the power-resource-constrained state.

As shown by reference number 930, the UE 120 may transmit, and the network node 110 may obtain, an indication that the UE 120 has exited the power-resource-constrained state. For example, the UE 120 may transmit a UAI message that contains the indication that the UE 120 has exited the power-resource-constrained state. For example, the UAI message may exclude the QMCRelease-Preference IE. The network node 110 obtaining the indication that the UE 120 has exited the power-resource-constrained state may enable the network node 110 to inform the OAM server 410 that the UE 120 has exited the power-resource-constrained state.

As shown by reference number 932, the network node 110 may output (e.g., forward), to the OAM server 410, the indication that the UE 120 has exited the power-resource-constrained state. For example, the network node 110 may determine that the UAI message implicitly indicates that the UE 120 is no longer in the power-saving mode based on the change in the UAI message (e.g., based on the absence of the QMCRelease-Preference IE) and, thus, that the UE preference to deactivate the QMC configurations has ended. The indication that the UE 120 has exited the power-resource-constrained state may include a QoE reference parameter. The indication may inform the OAM server 410 that the UE 120 has exited the power-resource-constrained state.

As shown by reference number 934, the modem 420 may provide, to the application 430(2), an indication (e.g., an AT command) that the UE 120 has exited the power-resource-constrained state. The indication may depend on a UE-specific implementation. For example, the application 430(2) may determine that the AT command implicitly indicates that the UE 120 is no longer in the power-saving mode based on an absence of the UE-powersaving parameter in the AT command. The indication that the UE 120 has exited the power-resource-constrained state may prompt the application 430(2) to cease including the UE-powersaving parameter in QoE report containers (e.g., the QoE report containers may no longer indicate that the UE 120 is in the power-resource-constrained state).

Examples 900A-900C are provided for management-based QoE configuration (e.g., where the OAM server 410 sends a QoE activation/deactivation configuration to the network node 110 directly). Implementations provided herein may also or alternatively apply to signaling-based QoE activation/deactivation (e.g., where the OAM server 410 sends the configurations to the network node 110 via a core network, such as a 5G core network). In some examples, the signaling provided in examples 900A-900C can be used in MN/SN implementations (e.g., in MCG/SCG implementations) in NR-DC scenarios.

As indicated above, FIG. 9 is provided as an example. Other examples may differ from what is described with respect to FIG. 9.

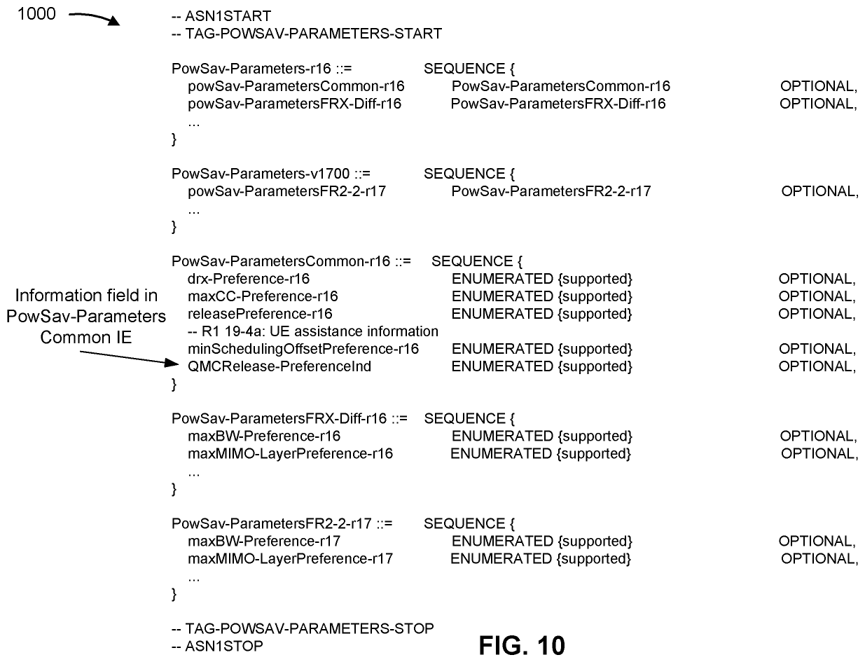

FIG. 10 is a diagram illustrating an example 1000 of capability information including an indication that the UE 120 is capable of transmitting a request to deactivate QMC configurations for applications for a power-resource-constrained state, in accordance with the present disclosure.

Example 1000 shows an information field that may be transmitted by the UE 120 and obtained by the network node 110 (e.g., as shown by reference number 902 in FIG. 9). For example, the QMCRelease-PreferenceInd parameter in the powSav-ParametersCommon IE for UE-NR-capability information may indicate whether the UE 120 supports indicating a UE preference to deactivate QMC configurations during a power saving mode. Table 1 above provides information relating to the QMCRelease-PreferenceInd parameter.

As indicated above, FIG. 10 is provided as an example. Other examples may differ from what is described with respect to FIG. 10.

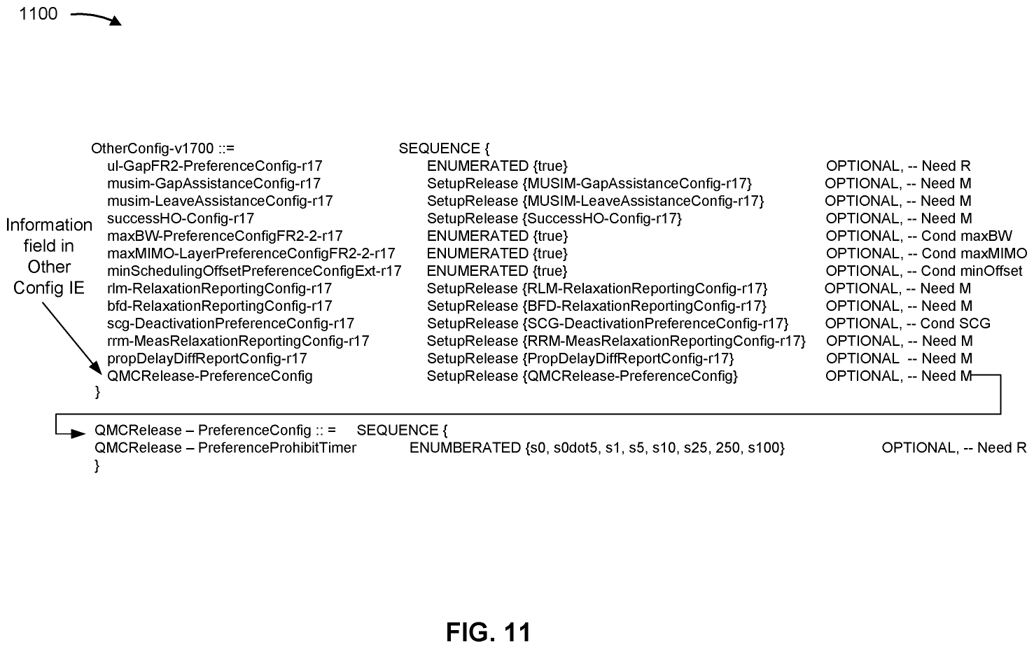

FIG. 11 is a diagram illustrating an example 1100 of a field for configuring the UE 120 with a timer configured to start based at least in part on the UE 120 entering a power-resource-constrained state, in accordance with the present disclosure.

The timer may be as described above in connection with reference numbers 904 and 908. For example, the UE 120 may transmit the request to deactivate the QMC configurations based at least in part on the timer expiring (e.g., after the timer expires). In some examples, the timer may be referred to as a prohibit timer (e.g., QMCRelease-PreferenceIndicationProhibitTimer, T3461 timer, or the like). The network node 110 may use the QMCRelease-PereferenceConfig field in the OtherConfig IE to configure the UE 120 with the timer. The value for the timer may be in units of seconds.

Example pseudocode for the timer is provided as follows:
1> If the received OtherConfig includes the QMCRelease-PereferenceConfig:
   2> If QMCRelease-PereferenceConfig is set to setup:
      3> consider itself to be configured to provide its preference on release of QMC configurations for power saving.
   2> else;
      3> consider itself not to be configured to provide its preference on release of QMC configurations for power saving and stop the timer T3461, if running.

As indicated above, FIG. 11 is provided as an example. Other examples may differ from what is described with respect to FIG. 11.

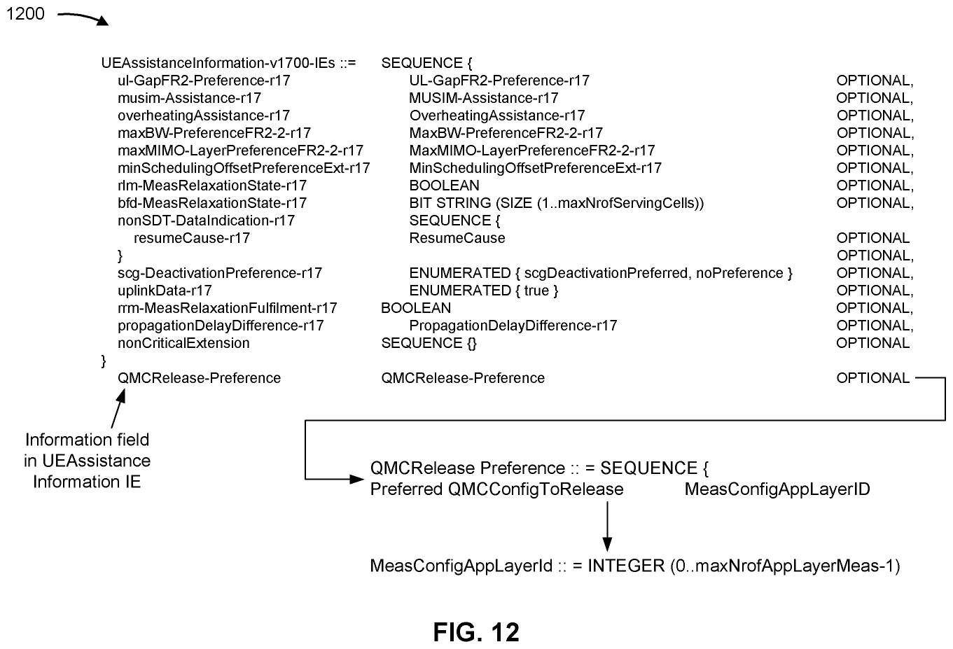

FIG. 12 is a diagram illustrating an example 1200 of a UAI message that contains the request to deactivate one or more QMC configurations, in accordance with the present disclosure.

Example 1200 shows an information field that may be transmitted by the UE 120 and obtained by the network node 110 (e.g., as shown by reference number 908 in FIG. 9). For example, the field QMCRelease-Preference in the UEAssistanceInformation IE may permit the UE 120 to indicate a UE preference to deactivate QMC configurations when the UE is in a power-saving mode (if the UE 120 has been configured to indicate the UE preference, e.g., as shown by reference number 904 in FIG. 9). The QMCRelease-Preference field being absent from the UEAssistanceInformation IE may indicate that the UE 120 has no preference regarding QoE measurement and reporting for applications of the UE 120 (e.g., the UE 120 is not requesting to deactivate the QMC configurations for the applications). The measConfigAppLayerID may identify one QMC configuration between the UE 120 and the network node 110. For example, the UE 120 may use the measConfigAppLayerID to identify the QMC configurations that the UE 120 requests to release.

As indicated above, FIG. 12 is provided as an example. Other examples may differ from what is described with respect to FIG. 12.

FIG. 13 is a diagram illustrating an example 1300 associated with indication of a UE resource-constrained state, in accordance with the present disclosure. As shown in FIG. 13, the OAM server 410, the network node 110, and the UE 120 may communicate with one another.

As shown by reference number 1310, the UE 120 may enter a thermal-resource-constrained state or a power-resource-constrained state. The UE 120 may enter the thermal-resource-constrained state in response to determining that the UE is overheating (e.g., an internal temperature of the UE exceeds a threshold). The power-resource-constrained state may be a power-saving mode that the UE 120 enters in response to determining that the stored battery of the UE 120 has fallen below a threshold. The UE 120 may enter the thermal-resource-constrained state as described above in connection with reference number 606 (FIG. 6A) or the power-resource-constrained state as described above in connection with reference number 906 (FIG. 9A).

In some aspects, the UE 120 may provide a command, to an application of the UE 120, to generate, during the thermal-resource-constrained state or the power-resource-constrained state, a QoE report container that contains an indication that the UE is in the thermal-resource-constrained state or the power-resource-constrained state. The UE 120 may provide the command (e.g., an AT command) as described above in connection with reference number 620 (FIG. 6B) or reference number 920 (FIG. 9B). For example, 3GPP QoE metrics may be updated for services supporting the NR QoE framework to include information regarding a UE thermal mitigation status and/or a UE power saving status in QoE report container. Absence, in the QoE report container, of the field that indicates that the UE is in the thermal-resource-constrained state or the power-resource-constrained state, may indicate that the UE 120 is not experiencing overheating or low power during the configured QoE measurement period.

In some examples, the UE 120 may obtain the QoE report container from the application. For example, the UE 120 may obtain the QoE report container as described above in connection with reference number 622 (FIG. 6B) or reference number 922 (FIG. 9B). In some examples, the application may be a high-priority application. For example, the OAM server 410 may determine the application to be high-priority as described above in connection with reference number 612 (FIG. 6B) or reference number 912 (FIG. 9B).

As shown by reference number 1320, the UE 120 transmits, and the network node 110 obtains, in the QoE report container, the indication that the UE is in the thermal-resource-constrained state or the power-resource-constrained state. The UE 120 may transmit, and the network node 110 may obtain, the indication as described above in connection with reference number 624 (FIG. 6A) or reference number 924 (FIG. 9A).

As shown by reference number 1330, the network node 110 may output, in the QoE report container, to the OAM server 410, the indication that the UE is in the thermal-resource-constrained state or the power-resource-constrained state. The network node 110 may output the indication in the QoE report container as described above in connection with reference number 626 (FIG. 6A) or reference number 926 (FIG. 9A). Thus, one or more modem thermal and power management entities on the UE 120 may provide UE overheating statuses, in the QoE report container, to QMC-supporting applications via the network node 110.

In some examples, as illustrated in FIGS. 6A-6C and 9A-9C, example 1300 may be implemented in conjunction with example 500. In some examples, example 1300 may be implemented independently from example 500. For example, the UE 120 may enter the power- or thermal-resource-constrained state and provide the indication in the QoE container in accordance with example 1300 before transmitting the request for QMC configuration deactivation in accordance with example 500. For example, the UE 120 may implement example 1300 and then, after a configured amount of time has passed or constrained resources have reached a configured threshold, implement example 500. In some examples, example 1300 may be implemented without example 500 (e.g., if the network node 110 has configured the UE 120 to perform example 1300 and has not configured the UE 120 to perform example 500).

The UE 120 transmitting, and the network node 110 obtaining, in the QoE report container, the indication that the UE is in the thermal-resource-constrained state or the power-resource-constrained state, and the network node 110 outputting, in the QoE report container, the indication that the UE is in the thermal-resource-constrained state or the power-resource-constrained state to the OAM server 410, may enable the OAM server 410 (and/or the service provider, MNO, OEM, or the like) to determine that the decreased QoE may be due to power-saving or overheating mitigation actions taken by the UE. As a result, instead of inaccurately interpreting QoE reports because UE mitigation actions are not reported to the network node 110, the OAM server 410 (and/or network node 110, application servers, or the like) may take proper adjustment actions based on the information in the QoE report container. Thus, introducing application (e.g., service) QoE metrics and IEs that enable the NR QoE framework to specify, in QoE reports, when the UE is in overheating and/or power saving situations may improve the value and utility of QoE reports for the network node 110, the OAM server 410, service providers, or the like.

As indicated above, FIG. 13 is provided as an example. Other examples may differ from what is described with respect to FIG. 13.

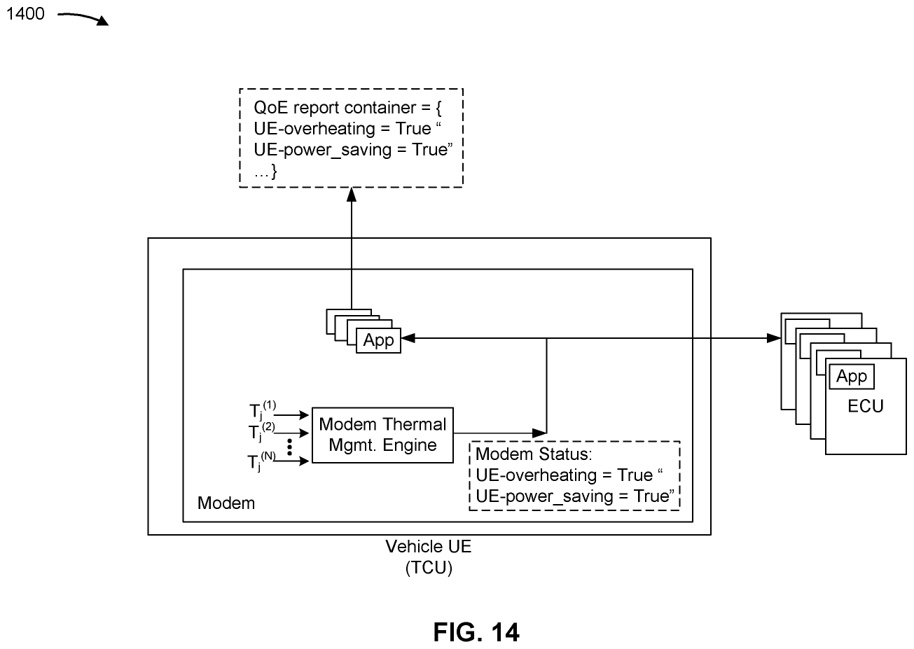

FIG. 14 is a diagram illustrating an example 1400 associated with indication of a vehicular UE thermal-resource-constrained state, in accordance with the present disclosure.

As shown, a vehicular UE may include a TCU that contains a modem and a plurality of electronic control units (ECUs). The vehicular UE may include applications running on the modem and/or respective ECUs. A modem thermal mitigation engine (e.g., a modem thermal mitigation processing engine) running on the modem may be responsible for managing a thermal-resource-constrained state entered by a vehicular UE.

For example, the modem thermal mitigation engine may obtain a plurality of temperatures (Tⱼ) of the vehicular UE. Upon detecting high temperature conditions of the vehicular UE based on the plurality of temperatures, the modem thermal mitigation engine may inform the applications, which may be configured by a network node for QMC, of a modem overheating status (“UE-overheating=True”). Additionally, or alternatively, the modem thermal mitigation engine may inform the applications of a modem power-saving status (“UE-power_saving=True”) upon detecting low power conditions of the vehicular UE.

The applications may provide transparent QoE report containers that include indications of the modem overheating status (“UE-overheating=True”), which may enable application servers (e.g., via an OAM server) and/or the network node to take efficient actions to improve user experience and overall application QoE performance. Additionally, or alternatively, the transparent QoE report containers may include indications of a modem power-saving status (“UE-power_saving=True”), if any. Thus, techniques described herein may indicate a UE overheating mode and/or a UE power saving mode as part of an NR QoE reporting mechanism.

As indicated above, FIG. 14 is provided as an example. Other examples may differ from what is described with respect to FIG. 14.

Techniques described herein may be compatible with any suitable solution for application layer measurement and reporting. For example, the techniques described herein may be used in any suitable proprietary solution for measurement and collection of application QoE data during UE overheating or power saving situations.

FIG. 15 is a diagram illustrating an example process 1500 performed, for example, by a UE, in accordance with the present disclosure. Example process 1500 is an example where the UE (e.g., UE 120) performs operations associated with handling a UE resource-constrained state.

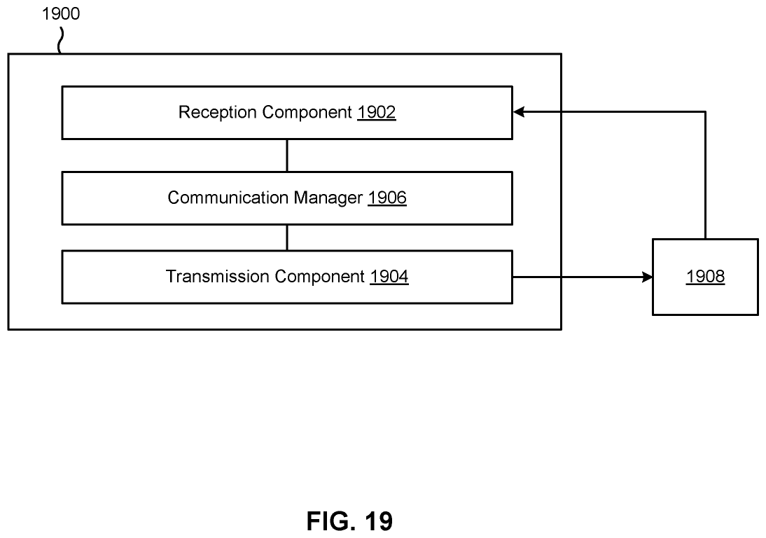

As shown in FIG. 15, in some aspects, process 1500 may include transmitting, based at least in part on a thermal-resource-constrained state of the UE or a power-resource-constrained state of the UE, a request to deactivate one or more QMC configurations for one or more applications (block 1510). For example, the UE (e.g., using transmission component 1904 and/or communication manager 1906, depicted in FIG. 19) may transmit, based at least in part on a thermal-resource-constrained state of the UE or a power-resource-constrained state of the UE, a request to deactivate one or more QMC configurations for one or more applications, as described above.

As further shown in FIG. 15, in some aspects, process 1500 may include receiving an indication to deactivate the one or more QMC configurations (block 1520). For example, the UE (e.g., using reception component 1902 and/or communication manager 1906, depicted in FIG. 19) may receive an indication to deactivate the one or more QMC configurations, as described above.

Process 1500 may include additional aspects, such as any single aspect or any combination of aspects described below and/or in connection with one or more other processes described elsewhere herein.

In a first aspect, process 1500 includes transmitting capability information including an indication that the UE is capable of transmitting the request to deactivate the one or more QMC configurations.

In a second aspect, alone or in combination with the first aspect, the request to deactivate the one or more QMC configurations includes one or more application layer identifiers corresponding to the one or more applications, and the indication to deactivate the one or more QMC configurations includes the one or more application layer identifiers.

In a third aspect, alone or in combination with one or more of the first and second aspects, receiving the indication to deactivate the one or more QMC configurations includes receiving the indication to deactivate the one or more QMC configurations based at least in part on a determination that the one or more applications are low-priority.

In a fourth aspect, alone or in combination with one or more of the first through third aspects, the one or more applications are one or more first applications of a plurality of applications that includes one or more second applications, and process 1500 further includes providing one or more commands, to the one or more second applications, to generate, during the thermal-resource-constrained state or the power-resource-constrained state, one or more QoE report containers.

In a fifth aspect, alone or in combination with one or more of the first through fourth aspects, process 1500 includes providing, to the one or more second applications, an indication that the UE has exited the thermal-resource-constrained state or the power-resource-constrained state.

In a sixth aspect, alone or in combination with one or more of the first through fifth aspects, process 1500 includes transmitting an indication that the UE has exited the thermal-resource-constrained state or the power-resource-constrained state.

In a seventh aspect, alone or in combination with one or more of the first through sixth aspects, the thermal-resource-constrained state or the power-resource-constrained state is the thermal-resource-constrained state.

In an eighth aspect, alone or in combination with one or more of the first through seventh aspects, the thermal-resource-constrained state or the power-resource-constrained state is the power-resource-constrained state.

In a ninth aspect, alone or in combination with one or more of the first through eighth aspects, process 1500 includes receiving a configuration of a timer configured to start based at least in part on the UE entering the power-resource-constrained state, and transmitting the request to deactivate the one or more QMC configurations includes transmitting the request to deactivate the one or more QMC configurations based at least in part on the timer expiring.

In a tenth aspect, alone or in combination with one or more of the first through ninth aspects, transmitting the request to deactivate the one or more QMC configurations includes transmitting a UAI message that contains the request to deactivate the one or more QMC configurations.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a UE, in accordance with the present disclosure. Example process 1600 is an example where the UE (e.g., UE 120) performs operations associated with handling a UE resource-constrained state.

As shown in FIG. 16, in some aspects, process 1600 may include entering a thermal-resource-constrained state or a power-resource-constrained state (block 1610). For example, the UE (e.g., using communication manager 1906, depicted in FIG. 19) may enter a thermal-resource-constrained state or a power-resource-constrained state, as described above.

As further shown in FIG. 16, in some aspects, process 1600 may include transmitting, in a QoE report container, an indication that the UE is in the thermal-resource-constrained state or the power-resource-constrained state (block 1620). For example, the UE (e.g., using transmission component 1904 and/or communication manager 1906, depicted in FIG. 19) may transmit, in a QoE report container, an indication that the UE is in the thermal-resource-constrained state or the power-resource-constrained state, as described above.

Process 1600 may include additional aspects, such as any single aspect or any combination of aspects described below and/or in connection with one or more other processes described elsewhere herein.

In a first aspect, process 1600 includes obtaining the QoE report container from an application.

In a second aspect, alone or in combination with the first aspect, process 1600 includes providing a command, to the application, to generate, during the thermal-resource-constrained state or the power-resource-constrained state, the QoE report container.

In a third aspect, alone or in combination with one or more of the first and second aspects, the application is determined to be high-priority.

In a fourth aspect, alone or in combination with one or more of the first through third aspects, the thermal-resource-constrained state or the power-resource-constrained state is the thermal-resource-constrained state.

In a fifth aspect, alone or in combination with one or more of the first through fourth aspects, the thermal-resource-constrained state or the power-resource-constrained state is the power-resource-constrained state.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a network node, in accordance with the present disclosure. Example process 1700 is an example where the network node (e.g., network node 110) performs operations associated with handling a UE resource-constrained state.

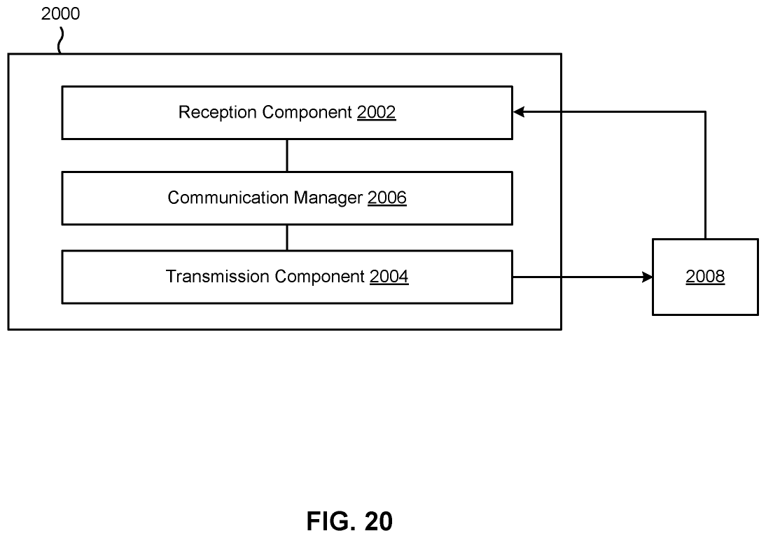

As shown in FIG. 17, in some aspects, process 1700 may include obtaining, based at least in part on a thermal-resource-constrained state of a UE or a power-resource-constrained state of the UE, a request to deactivate one or more QMC configurations for one or more applications (block 1710). For example, the network node (e.g., using reception component 2002 and/or communication manager 2006, depicted in FIG. 20) may obtain, based at least in part on a thermal-resource-constrained state of a UE or a power-resource-constrained state of the UE, a request to deactivate one or more QMC configurations for one or more applications, as described above.

As further shown in FIG. 17, in some aspects, process 1700 may include outputting an indication to deactivate the one or more QMC configurations (block 1720). For example, the network node (e.g., using transmission component 2004 and/or communication manager 2006, depicted in FIG. 20) may output an indication to deactivate the one or more QMC configurations, as described above.

Process 1700 may include additional aspects, such as any single aspect or any combination of aspects described below and/or in connection with one or more other processes described elsewhere herein.

In a first aspect, process 1700 includes obtaining capability information including an indication that the UE is capable of transmitting the request to deactivate the one or more QMC configurations.

In a second aspect, alone or in combination with the first aspect, the request to deactivate the one or more QMC configurations includes an indication of one or more application layer identifiers corresponding to the one or more applications, and the indication to deactivate the one or more QMC configurations includes the indication of the one or more application layer identifiers.

In a third aspect, alone or in combination with one or more of the first and second aspects, providing the indication to deactivate the one or more QMC configurations includes outputting the indication to deactivate the one or more QMC configurations based at least in part on a determination that the one or more applications are low-priority.

In a fourth aspect, alone or in combination with one or more of the first through third aspects, process 1700 includes obtaining an indication that the UE has exited the thermal-resource-constrained state or the power-resource-constrained state.

In a fifth aspect, alone or in combination with one or more of the first through fourth aspects, process 1700 includes outputting the indication that the UE has exited the thermal-resource-constrained state or the power-resource-constrained state to an OAM server.

In a sixth aspect, alone or in combination with one or more of the first through fifth aspects, process 1700 includes outputting, to an OAM server, the request to deactivate the one or more QMC configurations, and obtaining, from the OAM server, the indication to deactivate the one or more QMC configurations.

In a seventh aspect, alone or in combination with one or more of the first through sixth aspects, the thermal-resource-constrained state or the power-resource-constrained state is the thermal-resource-constrained state.

In an eighth aspect, alone or in combination with one or more of the first through seventh aspects, the thermal-resource-constrained state or the power-resource-constrained state is the power-resource-constrained state.

In a ninth aspect, alone or in combination with one or more of the first through eighth aspects, obtaining the request to deactivate the one or more QMC configurations includes obtaining a UAI message that contains the request to deactivate the one or more QMC configurations.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a network node, in accordance with the present disclosure. Example process 1800 is an example where the network node (e.g., network node 110) performs operations associated with handling a UE resource-constrained state.

As shown in FIG. 18, in some aspects, process 1800 may include obtaining, in a QoE report container, an indication that a UE is in a thermal-resource-constrained state or a power-resource-constrained state (block 1810). For example, the network node (e.g., using reception component 2002 and/or communication manager 2006, depicted in FIG. 20) may obtain, in a QoE report container, an indication that a UE is in a thermal-resource-constrained state or a power-resource-constrained state, as described above.

As further shown in FIG. 18, in some aspects, process 1800 may include outputting, in the QoE report container, to an OAM server, the indication that the UE is in the thermal-resource-constrained state or the power-resource-constrained state (block 1820). For example, the network node (e.g., using transmission component 2004 and/or communication manager 2006, depicted in FIG. 20) may output, in the QoE report container, to an OAM server, the indication that the UE is in the thermal-resource-constrained state or the power-resource-constrained state, as described above.

Process 1800 may include additional aspects, such as any single aspect or any combination of aspects described below and/or in connection with one or more other processes described elsewhere herein.

In a first aspect, the thermal-resource-constrained state or the power-resource-constrained state is the thermal-resource-constrained state.

In a second aspect, alone or in combination with the first aspect, the thermal-resource-constrained state or the power-resource-constrained state is the power-resource-constrained state.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a UE, or a UE may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 140 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 5, 6A-6C, 7, 8, 9A-9C, and 10-14. Additionally, or alternatively, the apparatus 1900 may be configured to perform one or more processes described herein, such as process 1500 of FIG. 15, process 1600 of FIG. 16, or a combination thereof. In some aspects, the apparatus 1900 and/or one or more components shown in FIG. 19 may include one or more components of the UE described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the UE described in connection with FIG. 2.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, a modem, a modulator, a transmit MIMO processor, a transmit processor, a controller/processor, a memory, or a combination thereof, of the UE described in connection with FIG. 2. In some aspects, the transmission component 1904 may be co-located with the reception component 1902 in a transceiver.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The transmission component 1904 may transmit, based at least in part on a thermal-resource-constrained state of the UE or a power-resource-constrained state of the UE, a request to deactivate one or more QMC configurations for one or more applications. The reception component 1902 may receive an indication to deactivate the one or more QMC configurations.

The transmission component 1904 may transmit capability information including an indication that the UE is capable of transmitting the request to deactivate the one or more QMC configurations.

The communication manager 1906 may provide, to the one or more second applications, an indication that the UE has exited the thermal-resource-constrained state or the power-resource-constrained state.

The transmission component 1904 may transmit an indication that the UE has exited the thermal-resource-constrained state or the power-resource-constrained state.

The reception component 1902 may receive a configuration of a timer configured to start based at least in part on the UE entering the power-resource-constrained state.

The transmission component 1904 may transmit the request to deactivate the one or more QMC configurations based at least in part on the timer expiring.

The communication manager 1906 may cause the UE to enter a thermal-resource-constrained state or a power-resource-constrained state. The transmission component 1904 may transmit, in a QoE report container, an indication that the UE is in the thermal-resource-constrained state or the power-resource-constrained state.

The communication manager 1906 may obtain the QoE report container from an application.

The communication manager 1906 may provide a command, to the application, to generate, during the thermal-resource-constrained state or the power-resource-constrained state, the QoE report container.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a network node, or a network node may include the apparatus 2000. In some aspects, the apparatus 2000 includes a reception component 2002, a transmission component 2004, and/or a communication manager 2006, which may be in communication with one another (for example, via one or more buses and/or one or more other components). In some aspects, the communication manager 2006 is the communication manager 150 described in connection with FIG. 1. As shown, the apparatus 2000 may communicate with another apparatus 2008, such as a UE or a network node (such as a CU, a DU, an RU, or a base station), using the reception component 2002 and the transmission component 2004.

In some aspects, the apparatus 2000 may be configured to perform one or more operations described herein in connection with FIGS. 5, 6A-6C, 7, 8, 9A-9C, and 10-14. Additionally, or alternatively, the apparatus 2000 may be configured to perform one or more processes described herein, such as process 1700 of FIG. 17, process 1800 of FIG. 18, or a combination thereof. In some aspects, the apparatus 2000 and/or one or more components shown in FIG. 20 may include one or more components of the network node described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the network node described in connection with FIG. 2. In some aspects, the reception component 2002 and/or the transmission component 2004 may include or may be included in a network interface. The network interface may be configured to obtain and/or output signals for the apparatus 2000 via one or more communications links, such as a backhaul link, a midhaul link, and/or a fronthaul link.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2008. In some aspects, the transmission component 2004 may include one or more antennas, a modem, a modulator, a transmit MIMO processor, a transmit processor, a controller/processor, a memory, or a combination thereof, of the network node described in connection with FIG. 2. In some aspects, the transmission component 2004 may be co-located with the reception component 2002 in a transceiver.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

The reception component 2002 may obtain, based at least in part on a thermal-resource-constrained state of a UE or a power-resource-constrained state of the UE, a request to deactivate one or more QMC configurations for one or more applications. The transmission component 2004 may output an indication to deactivate the one or more QMC configurations.

The reception component 2002 may obtain capability information including an indication that the UE is capable of transmitting the request to deactivate the one or more QMC configurations.

The reception component 2002 may obtain an indication that the UE has exited the thermal-resource-constrained state or the power-resource-constrained state.

The transmission component 2004 may output the indication that the UE has exited the thermal-resource-constrained state or the power-resource-constrained state to an OAM server.

The transmission component 2004 may output, to an OAM server, the request to deactivate the one or more QMC configurations.

The reception component 2002 may obtain, from the OAM server, the indication to deactivate the one or more QMC configurations.

The reception component 2002 may obtain, in a QoE report container, an indication that a UE is in a thermal-resource-constrained state or a power-resource-constrained state. The transmission component 2004 may output, in the QoE report container, to an OAM server, the indication that the UE is in the thermal-resource-constrained state or the power-resource-constrained state.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:

Aspect 1: A method of wireless communication performed by a UE, comprising: transmitting, based at least in part on a thermal-resource-constrained state of the UE or a power-resource-constrained state of the UE, a request to deactivate one or more QMC configurations for one or more applications; and receiving an indication to deactivate the one or more QMC configurations.

Aspect 2: The method of Aspect 1, further comprising: transmitting capability information including an indication that the UE is capable of transmitting the request to deactivate the one or more QMC configurations.

Aspect 3: The method of any of Aspects 1-2, wherein the request to deactivate the one or more QMC configurations includes one or more application layer identifiers corresponding to the one or more applications, and wherein the indication to deactivate the one or more QMC configurations includes the one or more application layer identifiers.

Aspect 4: The method of any of Aspects 1-3, wherein receiving the indication to deactivate the one or more QMC configurations includes: receiving the indication to deactivate the one or more QMC configurations based at least in part on a determination that the one or more applications are low-priority.

Aspect 5: The method of any of Aspects 1-4, wherein the one or more applications are one or more first applications of a plurality of applications that includes one or more second applications, the method further comprising: providing one or more commands, to the one or more second applications, to generate, during the thermal-resource-constrained state or the power-resource-constrained state, one or more QoE report containers.

Aspect 6: The method of Aspect 5, further comprising: providing, to the one or more second applications, an indication that the UE has exited the thermal-resource-constrained state or the power-resource-constrained state.

Aspect 7: The method of any of Aspects 1-6, further comprising: transmitting an indication that the UE has exited the thermal-resource-constrained state or the power-resource-constrained state.

Aspect 8: The method of any of Aspects 1-7, wherein the thermal-resource-constrained state or the power-resource-constrained state is the thermal-resource-constrained state.

Aspect 9: The method of any of Aspects 1-7, wherein the thermal-resource-constrained state or the power-resource-constrained state is the power-resource-constrained state.

Aspect 10: The method of Aspect 9, further comprising: receiving a configuration of a timer configured to start based at least in part on the UE entering the power-resource-constrained state, wherein transmitting the request to deactivate the one or more QMC configurations includes: transmitting the request to deactivate the one or more QMC configurations based at least in part on the timer expiring.

Aspect 11: The method of any of Aspects 1-10, wherein transmitting the request to deactivate the one or more QMC configurations includes: transmitting a UAI message that contains the request to deactivate the one or more QMC configurations.

Aspect 12: A method of wireless communication performed by a UE, comprising: entering a thermal-resource-constrained state or a power-resource-constrained state; and transmitting, in a QoE report container, an indication that the UE is in the thermal-resource-constrained state or the power-resource-constrained state.

Aspect 13: The method of Aspect 12, further comprising: obtaining the QoE report container from an application.

Aspect 14: The method of Aspect 13, further comprising: providing a command, to the application, to generate, during the thermal-resource-constrained state or the power-resource-constrained state, the QoE report container.

Aspect 15: The method of Aspect 13, wherein the application is determined to be high-priority.

Aspect 16: The method of any of Aspects 12-15, wherein the thermal-resource-constrained state or the power-resource-constrained state is the thermal-resource-constrained state.

Aspect 17: The method of any of Aspects 12-15, wherein the thermal-resource-constrained state or the power-resource-constrained state is the power-resource-constrained state.

Aspect 18: A method of wireless communication performed by a network node, comprising: obtaining, based at least in part on a thermal-resource-constrained state of a UE or a power-resource-constrained state of the UE, a request to deactivate one or more QMC configurations for one or more applications; and outputting an indication to deactivate the one or more QMC configurations.

Aspect 19: The method of Aspect 18, further comprising: obtaining capability information including an indication that the UE is capable of transmitting the request to deactivate the one or more QMC configurations.

Aspect 20: The method of any of Aspects 18-19, wherein the request to deactivate the one or more QMC configurations includes an indication of one or more application layer identifiers corresponding to the one or more applications, and wherein the indication to deactivate the one or more QMC configurations includes the indication of the one or more application layer identifiers.

Aspect 21: The method of any of Aspects 18-20, wherein providing the indication to deactivate the one or more QMC configurations includes: outputting the indication to deactivate the one or more QMC configurations based at least in part on a determination that the one or more applications are low-priority.

Aspect 22: The method of any of Aspects 18-21, further comprising: obtaining an indication that the UE has exited the thermal-resource-constrained state or the power-resource-constrained state.

Aspect 23: The method of Aspect 22, further comprising: outputting the indication that the UE has exited the thermal-resource-constrained state or the power-resource-constrained state to an OAM server.

Aspect 24: The method of any of Aspects 18-23, further comprising: outputting, to an OAM server, the request to deactivate the one or more QMC configurations; and obtaining, from the OAM server, the indication to deactivate the one or more QMC configurations.

Aspect 25: The method of any of Aspects 18-24, wherein the thermal-resource-constrained state or the power-resource-constrained state is the thermal-resource-constrained state.

Aspect 26: The method of any of Aspects 18-24, wherein the thermal-resource-constrained state or the power-resource-constrained state is the power-resource-constrained state.

Aspect 27: The method of any of Aspects 18-26, wherein obtaining the request to deactivate the one or more QMC configurations includes: obtaining a UAI message that contains the request to deactivate the one or more QMC configurations.

Aspect 28: A method of wireless communication performed by a network node, comprising: obtaining, in a QoE report container, an indication that a UE is in a thermal-resource-constrained state or a power-resource-constrained state; and outputting, in the QoE report container, to an OAM server, the indication that the UE is in the thermal-resource-constrained state or the power-resource-constrained state.

Aspect 29: The method of Aspect 28, wherein the thermal-resource-constrained state or the power-resource-constrained state is the thermal-resource-constrained state.

Aspect 30: The method of Aspect 28, wherein the thermal-resource-constrained state or the power-resource-constrained state is the power-resource-constrained state.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
transmit, based at least in part on a thermal-resource-constrained state of the UE or a power-resource-constrained state of the UE, a request to deactivate one or more quality of experience (QoE) measurement and collection (QMC) configurations for one or more applications; and
receive an indication to deactivate the one or more QMC configurations.

2. The UE of claim 1, wherein the one or more processors are further configured to cause the UE to:
transmit capability information including an indication that the UE is capable of transmitting the request to deactivate the one or more QMC configurations.

3. The UE of claim 1, wherein the request to deactivate the one or more QMC configurations includes one or more application layer identifiers corresponding to the one or more applications, and wherein the indication to deactivate the one or more QMC configurations includes the one or more application layer identifiers.

4. The UE of claim 1, wherein the one or more processors, to receive the indication to deactivate the one or more QMC configurations, are configured to cause the UE to:
receive the indication to deactivate the one or more QMC configurations based at least in part on a determination that the one or more applications are low-priority.

5. The UE of claim 1, wherein the one or more applications are one or more first applications of a plurality of applications that includes one or more second applications, and wherein the one or more processors are further configured to cause the UE to:
provide one or more commands, to the one or more second applications, to generate, during the thermal-resource-constrained state or the power-resource-constrained state, one or more QoE report containers.

6. The UE of claim 5, wherein the one or more processors are further configured to cause the UE to:
provide, to the one or more second applications, an indication that the UE has exited the thermal-resource-constrained state or the power-resource-constrained state.

7. The UE of claim 1, wherein the one or more processors are further configured to cause the UE to:
transmit an indication that the UE has exited the thermal-resource-constrained state or the power-resource-constrained state.

8. The UE of claim 1, wherein the thermal-resource-constrained state or the power-resource-constrained state is the thermal-resource-constrained state.

9. The UE of claim 1, wherein the thermal-resource-constrained state or the power-resource-constrained state is the power-resource-constrained state.

10. The UE of claim 9, wherein the one or more processors are further configured to cause the UE to:
receive a configuration of a timer configured to start based at least in part on the UE entering the power-resource-constrained state, wherein the one or more processors, to transmit the request to deactivate the one or more QMC configurations, are configured to cause the UE to:
transmit the request to deactivate the one or more QMC configurations based at least in part on the timer expiring.

11. The UE of claim 1, wherein the one or more processors, to transmit the request to deactivate the one or more QMC configurations, are configured to cause the UE to:
transmit a UE assistance information (UAI) message that contains the request to deactivate the one or more QMC configurations.

12. A UE for wireless communication, comprising:
one or more memories; and
one or more processors, coupled to the one or more memories, configured to cause the UE to:
enter a thermal-resource-constrained state or a power-resource-constrained state; and
transmit, in a quality of experience (QoE) report container, an indication that the UE is in the thermal-resource-constrained state or the power-resource-constrained state.

13. The UE of claim 12, wherein the one or more processors are further configured to cause the UE to:
obtain the QoE report container from an application.

14. The UE of claim 13, wherein the one or more processors are further configured to cause the UE to:
provide a command, to the application, to generate, during the thermal-resource-constrained state or the power-resource-constrained state, the QoE report container.

15. The UE of claim 13, wherein the application is determined to be high-priority.

16. The UE of claim 12, wherein the thermal-resource-constrained state or the power-resource-constrained state is the thermal-resource-constrained state.

17. The UE of claim 12, wherein the thermal-resource-constrained state or the power-resource-constrained state is the power-resource-constrained state.

18. A network node for wireless communication, comprising:
one or more memories; and
one or more processors, coupled to the one or more memories, configured to cause the network node to:
obtain, based at least in part on a thermal-resource-constrained state of a user equipment (UE) or a power-resource-constrained state of the UE, a request to deactivate one or more quality of experience (QoE) measurement and collection (QMC) configurations for one or more applications; and
output an indication to deactivate the one or more QMC configurations.

19. The network node of claim 18, wherein the one or more processors are further configured to cause the network node to:
obtain capability information including an indication that the UE is capable of transmitting the request to deactivate the one or more QMC configurations.

20. The network node of claim 18, wherein the request to deactivate the one or more QMC configurations includes an indication of one or more application layer identifiers corresponding to the one or more applications, and wherein the indication to deactivate the one or more QMC configurations includes the indication of the one or more application layer identifiers.

21. The network node of claim 18, wherein the one or more processors, to provide the indication to deactivate the one or more QMC configurations, are configured to cause the network node to:
output the indication to deactivate the one or more QMC configurations based at least in part on a determination that the one or more applications are low-priority.

22. The network node of claim 18, wherein the one or more processors are further configured to cause the network node to:
obtain an indication that the UE has exited the thermal-resource-constrained state or the power-resource-constrained state.

23. The network node of claim 22, wherein the one or more processors are further configured to cause the network node to:
output the indication that the UE has exited the thermal-resource-constrained state or the power-resource-constrained state to an operations, administration, and maintenance (OAM) server.

24. The network node of claim 18, wherein the one or more processors are further configured to cause the network node to:
output, to an operations, administration, and maintenance (OAM) server, the request to deactivate the one or more QMC configurations; and
obtain, from the OAM server, the indication to deactivate the one or more QMC configurations.

25. The network node of claim 18, wherein the thermal-resource-constrained state or the power-resource-constrained state is the thermal-resource-constrained state.

26. The network node of claim 18, wherein the thermal-resource-constrained state or the power-resource-constrained state is the power-resource-constrained state.

27. The network node of claim 18, wherein the one or more processors, to obtain the request to deactivate the one or more QMC configurations, are configured to cause the network node to:
obtain a UE assistance information (UAI) message that contains the request to deactivate the one or more QMC configurations.

28. A network node for wireless communication, comprising:
one or more memories; and
one or more processors, coupled to the one or more memories, configured to cause the network node to:
obtain, in a quality of experience (QoE) report container, an indication that a user equipment (UE) is in a thermal-resource-constrained state or a power-resource-constrained state; and
output, in the QoE report container, to an operations, administration, and maintenance (OAM) server, the indication that the UE is in the thermal-resource-constrained state or the power-resource-constrained state.

29. The network node of claim 28, wherein the thermal-resource-constrained state or the power-resource-constrained state is the thermal-resource-constrained state.

30. The network node of claim 28, wherein the thermal-resource-constrained state or the power-resource-constrained state is the power-resource-constrained state.
